(19) United States
(12) Patent Application Publication
(10) Pub. No.: US 2024/0324021 A1
(43) Pub. Date: Sep. 26, 2024

(54) CARRIER SELECTION FOR DOWNLINK RANDOM ACCESS MESSAGES

(71) Applicant: QUALCOMM Incorporated, San Diego, CA (US)

(72) Inventors: Hung Dinh LY, San Diego, CA (US); Hwan Joon KWON, San Diego, CA (US); Kexin XIAO, Shanghai (CN)

(21) Appl. No.: 18/579,220

(22) PCT Filed: Sep. 28, 2021
(86) PCT No.: PCT/CN2021/121148

§ 371 Date: Jan. 12, 2024

(51) Int. Cl. H04W 74/0833; H04W 72/0453; H04W 74/00

(52) U.S. Cl. CPC H04W 74/0833; H04W 72/0453; H04W 74/006

(57) ABSTRACT

Methods, systems, and devices for wireless communication are described to support an indication of one or more carriers of a flexible cell to be used for reception of one or more respective downlink random access messages. A base station may indicate, via system information, a carrier for reception of a downlink control channel scheduling a second random access message. A user equipment (UE) may initiate a random access procedure by transmitting, to the base station, a first random access message. The UE may monitor for and receive the downlink control channel scheduling the second random access message via the carrier indicated in the system information. The UE may receive the second random access message via the same carrier as the associated downlink control channel, or via a different carrier that may be indicated in the system information or in the downlink control channel transmission.

### CROSS REFERENCE

The present application is a 371 national stage filing of International PCT Application No. PCT/CN2021/121148 by LY et al. entitled “CARRIER SELECTION FOR DOWNLINK RANDOM ACCESS MESSAGES,” filed Sep. 28, 2021, which is assigned to the assignee hereof, and which is expressly incorporated by reference in its entirety herein.

### FIELD OF TECHNOLOGY

The following relates to wireless communication, including carrier selection for downlink random access messages.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may perform a random access procedure in order to establish communications with a base station, among other examples. In some cases, one or more communication parameters may be unknown to the UE when initiating the random access procedure.

### SUMMARY

The described techniques relate to improved methods, systems, devices, and apparatuses that support carrier selection for downlink random access messages. Generally, the described techniques provide for indicating one or more carriers of a flexible cell to be used for reception of one or more respective downlink random access messages. For example, a base station may indicate, via system information, a carrier for reception of a downlink control channel scheduling a second random access message. A user equipment (UE) may initiate a random access procedure by transmitting, to the base station, a first random access message. The UE may monitor for and receive the downlink control channel scheduling the second random access message via the carrier indicated in the system information. In some cases, the UE may receive the second random access message via the same carrier as the associated downlink control channel, or via a different carrier that may be indicated in the system information or in the downlink control channel transmission. In a four-step random access procedure, a respective carrier of the flexible cell for reception of one or more other downlink control channels or random access messages may be indicated via the system information or via a previous downlink random access message or control channel. In such cases, the UE may receive the corresponding downlink random access message or control channel via the indicated carrier of the flexible cell.

A method for wireless communication at a UE is described. The method may include receiving, from a base station, system information for a cell that includes an anchor carrier and one or more other carriers, the system information including an indication of a first other carrier of the one or more other carriers for receiving a downlink control channel scheduling a second random access message, transmitting a first random access message for a random access procedure, and receiving, in response to the first random access message and via the first other carrier, the downlink control channel scheduling the second random access message.

An apparatus for wireless communication at a UE is described. The apparatus may include a memory and a processor coupled to the memory. The processor may be configured to receive, from a base station, system information for a cell that includes an anchor carrier and one or more other carriers, the system information including an indication of a first other carrier of the one or more other carriers for receiving a downlink control channel scheduling a second random access message, transmit a first random access message for a random access procedure, and receive, in response to the first random access message and via the first other carrier, the downlink control channel scheduling the second random access message.

Another apparatus for wireless communication at a UE is described. The apparatus may include means for receiving, from a base station, system information for a cell that includes an anchor carrier and one or more other carriers, the system information including an indication of a first other carrier of the one or more other carriers for receiving a downlink control channel scheduling a second random access message, means for transmitting a first random access message for a random access procedure, and means for receiving, in response to the first random access message and via the first other carrier, the downlink control channel scheduling the second random access message.

A non-transitory computer-readable medium storing code for wireless communication at a UE is described. The code may include instructions executable by a processor to receive, from a base station, system information for a cell that includes an anchor carrier and one or more other carriers, the system information including an indication of a first other carrier of the one or more other carriers for receiving a downlink control channel scheduling a second random access message, transmit a first random access message for a random access procedure, and receive, in response to the first random access message and via the first other carrier, the downlink control channel scheduling the second random access message.

Some examples of the method, apparatuses, and non-transitory computer-readable medium described herein may further include operations, features, means, or instructions for receiving the second random access message via the first other carrier based on the indication of the first other carrier in the system information and in response to receiving the downlink control channel scheduling the second random access message.

Some examples of the method, apparatuses, and non-transitory computer-readable medium described herein may further include operations, features, means, or instructions for receiving, via the system information, an indication of a second other carrier for receiving the second random access message and receiving the second random access message via the second other carrier based on the indication of the second other carrier in the system information and in response to receiving the downlink control channel scheduling the second random access message.

Some examples of the method, apparatuses, and non-transitory computer-readable medium described herein may further include operations, features, means, or instructions for receiving, via the downlink control channel, an indication of a second other carrier for receiving the second random access message and receiving the second random access message via the second other carrier based on the indication of the second other carrier in the downlink control channel and in response to receiving the downlink control channel scheduling the second random access message.

Some examples of the method, apparatuses, and non-transitory computer-readable medium described herein may further include operations, features, means, or instructions for receiving, via the first other carrier, a second downlink control channel scheduling a third random access message based on the indication of the first other carrier in the system information.

Some examples of the method, apparatuses, and non-transitory computer-readable medium described herein may further include operations, features, means, or instructions for receiving, via a second other carrier, a second downlink control channel scheduling a third random access message based on receiving the second random access message via the second other carrier.

Some examples of the method, apparatuses, and non-transitory computer-readable medium described herein may further include operations, features, means, or instructions for receiving an indication of a third other carrier for a second downlink control channel scheduling a third random access message, where the indication of the third other carrier may be received via the system information, the downlink control channel, the second random access message, or any combination thereof and receiving, via the third other carrier, the second downlink control channel based on the indication of the third other carrier.

Some examples of the method, apparatuses, and non-transitory computer-readable medium described herein may further include operations, features, means, or instructions for receiving, via the first other carrier, a third downlink control channel scheduling a fourth random access message based on the indication of the first other carrier in the system information.

Some examples of the method, apparatuses, and non-transitory computer-readable medium described herein may further include operations, features, means, or instructions for receiving, via a second other carrier, a third downlink control channel scheduling a fourth random access message based on receiving the second random access message via the second other carrier.

Some examples of the method, apparatuses, and non-transitory computer-readable medium described herein may further include operations, features, means, or instructions for receiving, via a third other carrier, a third downlink control channel scheduling a fourth random access message based on receiving, via the third other carrier, a second downlink control channel scheduling a third random access message.

Some examples of the method, apparatuses, and non-transitory computer-readable medium described herein may further include operations, features, means, or instructions for receiving an indication of a fourth other carrier for a third downlink control channel scheduling a fourth random access message, where the indication of the fourth other carrier may be received via the system information, the downlink control channel, the second random access message, a second downlink control channel scheduling a third random access message, or any combination thereof and receiving, via the fourth other carrier, the third downlink control channel based on the indication of the fourth other carrier.

Some examples of the method, apparatuses, and non-transitory computer-readable medium described herein may further include operations, features, means, or instructions for receiving, via the first other carrier, a fourth random access message based on the indication of the first other carrier in the system information.

Some examples of the method, apparatuses, and non-transitory computer-readable medium described herein may further include operations, features, means, or instructions for receiving, via a second other carrier, a fourth random access message based on receiving the second random access message via the second other carrier.

Some examples of the method, apparatuses, and non-transitory computer-readable medium described herein may further include operations, features, means, or instructions for receiving, via a third other carrier, a fourth random access message based on receiving, via the third other carrier, a second downlink control channel scheduling a third random access message.

Some examples of the method, apparatuses, and non-transitory computer-readable medium described herein may further include operations, features, means, or instructions for receiving, via a fourth other carrier, a fourth random access message based on receiving, via the fourth other carrier, a third downlink control channel scheduling the fourth random access message.

Some examples of the method, apparatuses, and non-transitory computer-readable medium described herein may further include operations, features, means, or instructions for receiving an indication of a fifth other carrier for a fourth random access message, where the indication of the fifth other carrier may be received via the system information, the downlink control channel, the second random access message, a second downlink control channel scheduling a third random access message, a third downlink control channel scheduling the fourth random access message, or any combination thereof and receiving, via the fifth other carrier, the fourth random access message based on the indication of the fifth other carrier.

In some examples of the method, apparatuses, and non-transitory computer-readable medium described herein, the cell includes a flexible cell that includes a set of non-aggregated carriers, the set of non-aggregated carriers including the anchor carrier and the one or more other carriers and the one or more other carriers includes one or more non-anchor carriers.

In some examples of the method, apparatuses, and non-transitory computer-readable medium described herein, the second random access message may be a message 2 (msg2) and the random access procedure may be a four-step random access procedure or the second random access message may be a message B (msgB) and the random access procedure may be a two-step random access procedure.

A method for wireless communication at a base station is described. The method may include transmitting, to a UE, system information for a cell that includes an anchor carrier and one or more other carriers, the system information including an indication of a first other carrier of the one or more other carriers for transmitting a downlink control channel scheduling a second random access message, receiving, from the UE, a first random access message for a random access procedure, and transmitting, in response to the first random access message and via the first other carrier, the downlink control channel scheduling the second random access message.

An apparatus for wireless communication at a base station is described. The apparatus may include a memory and a processor coupled to the memory. The processor may be configured to cause the apparatus to transmit, to a UE, system information for a cell that includes an anchor carrier and one or more other carriers, the system information including an indication of a first other carrier of the one or more other carriers for transmitting a downlink control channel scheduling a second random access message, receive, from the UE, a first random access message for a random access procedure, and transmit, in response to the first random access message and via the first other carrier, the downlink control channel scheduling the second random access message.

Another apparatus for wireless communication at a base station is described. The apparatus may include means for transmitting, to a UE, system information for a cell that includes an anchor carrier and one or more other carriers, the system information including an indication of a first other carrier of the one or more other carriers for transmitting a downlink control channel scheduling a second random access message, means for receiving, from the UE, a first random access message for a random access procedure, and means for transmitting, in response to the first random access message and via the first other carrier, the downlink control channel scheduling the second random access message.

A non-transitory computer-readable medium storing code for wireless communication at a base station is described. The code may include instructions executable by a processor to transmit, to a UE, system information for a cell that includes an anchor carrier and one or more other carriers, the system information including an indication of a first other carrier of the one or more other carriers for transmitting a downlink control channel scheduling a second random access message, receive, from the UE, a first random access message for a random access procedure, and transmit, in response to the first random access message and via the first other carrier, the downlink control channel scheduling the second random access message.

Some examples of the method, apparatuses, and non-transitory computer-readable medium described herein may further include operations, features, means, or instructions for transmitting the second random access message via the first other carrier based on the indication of the first other carrier in the system information and in response to transmitting the downlink control channel scheduling the second random access message.

Some examples of the method, apparatuses, and non-transitory computer-readable medium described herein may further include operations, features, means, or instructions for transmitting, via the system information, an indication of a second other carrier for transmitting the second random access message and transmitting the second random access message via the second other carrier based on the indication of the second other carrier in the system information and in response to transmitting the downlink control channel scheduling the second random access message.

Some examples of the method, apparatuses, and non-transitory computer-readable medium described herein may further include operations, features, means, or instructions for transmitting, via the downlink control channel, an indication of a second other carrier for transmitting the second random access message and transmitting the second random access message via the second other carrier based on the indication of the second other carrier in the downlink control channel and in response to transmitting the downlink control channel scheduling the second random access message.

Some examples of the method, apparatuses, and non-transitory computer-readable medium described herein may further include operations, features, means, or instructions for transmitting, via the first other carrier, a second downlink control channel scheduling a third random access message based on the indication of the first other carrier in the system information.

Some examples of the method, apparatuses, and non-transitory computer-readable medium described herein may further include operations, features, means, or instructions for transmitting, via a second other carrier, a second downlink control channel scheduling a third random access message based on transmitting the second random access message via the second other carrier.

Some examples of the method, apparatuses, and non-transitory computer-readable medium described herein may further include operations, features, means, or instructions for transmitting an indication of a third other carrier for a second downlink control channel scheduling a third random access message, where the indication of the third other carrier may be transmitted via the system information, the downlink control channel, the second random access message, or any combination thereof and transmitting, via the third other carrier, the second downlink control channel based on the indication of the third other carrier.

Some examples of the method, apparatuses, and non-transitory computer-readable medium described herein may further include operations, features, means, or instructions for transmitting, via the first other carrier, a third downlink control channel scheduling a fourth random access message based on the indication of the first other carrier in the system information.

Some examples of the method, apparatuses, and non-transitory computer-readable medium described herein may further include operations, features, means, or instructions for transmitting, via a second other carrier, a third downlink control channel scheduling a fourth random access message based on transmitting the second random access message via the second other carrier.

Some examples of the method, apparatuses, and non-transitory computer-readable medium described herein may further include operations, features, means, or instructions for transmitting, via a third other carrier, a third downlink control channel scheduling a fourth random access message based on transmitting, via the third other carrier, a second downlink control channel scheduling a third random access message.

Some examples of the method, apparatuses, and non-transitory computer-readable medium described herein may further include operations, features, means, or instructions for transmitting an indication of a fourth other carrier for a third downlink control channel scheduling a fourth random access message, where the indication of the fourth other carrier may be transmitted via the system information, the downlink control channel, the second random access message, a second downlink control channel scheduling a third random access message, or any combination thereof and transmitting, via the fourth other carrier, the third downlink control channel based on the indication of the fourth other carrier.

Some examples of the method, apparatuses, and non-transitory computer-readable medium described herein may further include operations, features, means, or instructions for transmitting, via the first other carrier, a fourth random access message based on the indication of the first other carrier in the system information.

Some examples of the method, apparatuses, and non-transitory computer-readable medium described herein may further include operations, features, means, or instructions for transmitting, via a second other carrier, a fourth random access message based on transmitting the second random access message via the second other carrier.

Some examples of the method, apparatuses, and non-transitory computer-readable medium described herein may further include operations, features, means, or instructions for transmitting, via a third other carrier, a fourth random access message based on transmitting, via the third other carrier, a second downlink control channel scheduling a third random access message.

Some examples of the method, apparatuses, and non-transitory computer-readable medium described herein may further include operations, features, means, or instructions for transmitting, via a fourth other carrier, a fourth random access message based on transmitting, via the fourth other carrier, a third downlink control channel scheduling the fourth random access message.

Some examples of the method, apparatuses, and non-transitory computer-readable medium described herein may further include operations, features, means, or instructions for transmitting an indication of a fifth other carrier for a fourth random access message, where the indication of the fifth other carrier may be transmitted via the system information, the downlink control channel, the second random access message, a second downlink control channel scheduling a third random access message, a third downlink control channel scheduling the fourth random access message, or any combination thereof and transmitting, via the fifth other carrier, the fourth random access message based on the indication of the fifth other carrier.

In some examples of the method, apparatuses, and non-transitory computer-readable medium described herein, the cell includes a flexible cell that includes a set of non-aggregated carriers, the set of non-aggregated carriers including the anchor carrier and the one or more other carriers and the one or more other carriers includes one or more non-anchor carriers.

In some examples of the method, apparatuses, and non-transitory computer-readable medium described herein, the second random access message may be a msg2 and the random access procedure may be a four-step random access procedure or the second random access message may be a msgB and the random access procedure may be a two-step random access procedure.

### BRIEF DESCRIPTION OF THE DRAWINGS

FIG. 1 illustrates an example of a wireless communications system that supports carrier selection for downlink random access messages in accordance with aspects of the present disclosure.

FIG. 2 illustrates an example of a wireless communications system that supports carrier selection for downlink random access messages in accordance with aspects of the present disclosure.

FIG. 3 illustrates an example of a process flow that supports carrier selection for downlink random access messages in accordance with aspects of the present disclosure.

FIG. 4 illustrates an example of a process flow that supports carrier selection for downlink random access messages in accordance with aspects of the present disclosure.

FIGS. 5 and 6 show block diagrams of devices that support carrier selection for downlink random access messages in accordance with aspects of the present disclosure.

FIG. 7 shows a block diagram of a communications manager that supports carrier selection for downlink random access messages in accordance with aspects of the present disclosure.

FIG. 8 shows a diagram of a system including a device that supports carrier selection for downlink random access messages in accordance with aspects of the present disclosure.

FIGS. 9 and 10 show block diagrams of devices that support carrier selection for downlink random access messages in accordance with aspects of the present disclosure.

FIG. 11 shows a block diagram of a communications manager that supports carrier selection for downlink random access messages in accordance with aspects of the present disclosure.

FIG. 12 shows a diagram of a system including a device that supports carrier selection for downlink random access messages in accordance with aspects of the present disclosure.

FIGS. 13 through 16 show flowcharts illustrating methods that support carrier selection for downlink random access messages in accordance with aspects of the present disclosure.

### DETAILED DESCRIPTION

A base station may include or support a flexible cell (e.g., an elastic cell), which may be a cell with a collection of multiple carriers (e.g., any combination of carriers). A set of carriers of the flexible cell may include an anchor carrier and one or more non-anchor carriers. For example, the flexible cell may include an anchor carrier, a first non-anchor carrier, and a second non-anchor carrier. Other examples of a flexible cell may include any quantity of carriers (e.g., one anchor carrier and one or more non-anchor carriers, such as one non-anchor carrier or three or more non-anchor carriers).

In some cases, downlink random access messages may be transmitted via the anchor carrier of the flexible cell. The downlink random access messages may include transmissions of a downlink control channel and a shared channel for a second random access message (e.g., for a two-step or a four-step random access procedure) or for a fourth random access message (e.g., for a four-step random access procedure), or may include transmissions of a downlink control channel for a third random access message (e.g., for a four-step random access procedure). Because multiple carriers (e.g., an anchor carrier and up to N non-anchor carriers) may be available for communication on the flexible cell, a user equipment (UE) may not be aware of which carrier to use (e.g., to monitor) for reception of one or more of the downlink random access messages, especially if such a carrier is not the anchor carrier (e.g., a non-anchor carrier is used for downlink transmissions).

The present disclosure provides techniques for indicating one or more carriers of a flexible cell to be used for reception of one or more respective downlink random access messages. For example, the base station may indicate, via system information, a carrier for reception of a downlink control channel scheduling a second random access message. When initiating a random access procedure, the UE may transmit, to the base station, a first random access message. The UE may monitor for and receive the downlink control channel scheduling the second random access message via the carrier indicated in the system information.

In some cases, the UE may receive the second random access message via the same carrier as the associated downlink control channel, or via a different carrier that may be indicated in the system information or in the downlink control channel transmission. In a four-step random access procedure, a respective carrier of the flexible cell for reception of a downlink control channel for retransmission of a third random access message, for reception of a downlink control channel for a fourth random access message, or for reception of the fourth random access message, may be indicated via the system information or via a previous downlink random access message. In such cases, the UE may receive the corresponding downlink random access message via the indicated carrier of the flexible cell.

Aspects of the disclosure are initially described in the context of wireless communications systems. Aspects of the disclosure are further illustrated by and described with reference to process flows, apparatus diagrams, system diagrams, and flowcharts that relate to carrier selection for downlink random access messages.

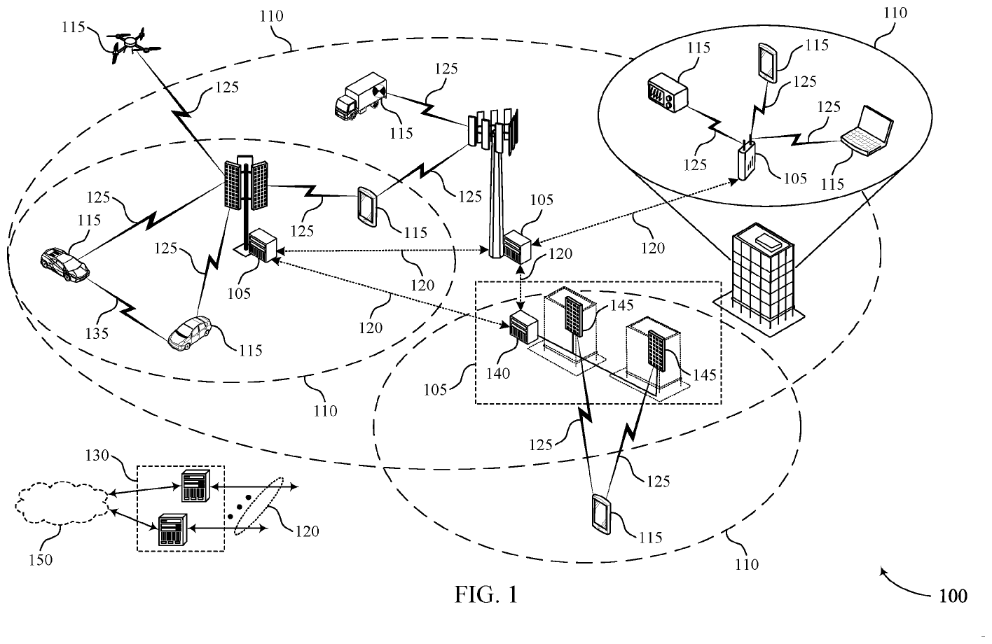

FIG. 1 illustrates an example of a wireless communications system 100 that supports carrier selection for downlink random access messages in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may indicate, via system information, a carrier for reception of a downlink control channel scheduling a second random access message. When initiating a random access procedure, a UE 115 may transmit, to the base station 105, a first random access message. The UE 115 may monitor for and receive the downlink control channel scheduling the second random access message via the carrier indicated in the system information. In some cases, the UE 115 may receive the second random access message via the same carrier as the associated downlink control channel, or via a different carrier that may be indicated in the system information or in the downlink control channel transmission. In a four-step random access procedure, a respective carrier of the flexible cell for reception of one or more other downlink control channels or random access messages may be indicated via the system information or via a previous downlink random access message or control channel. In such cases, the UE may receive the corresponding downlink random access message or control channel via the indicated carrier of the flexible cell.

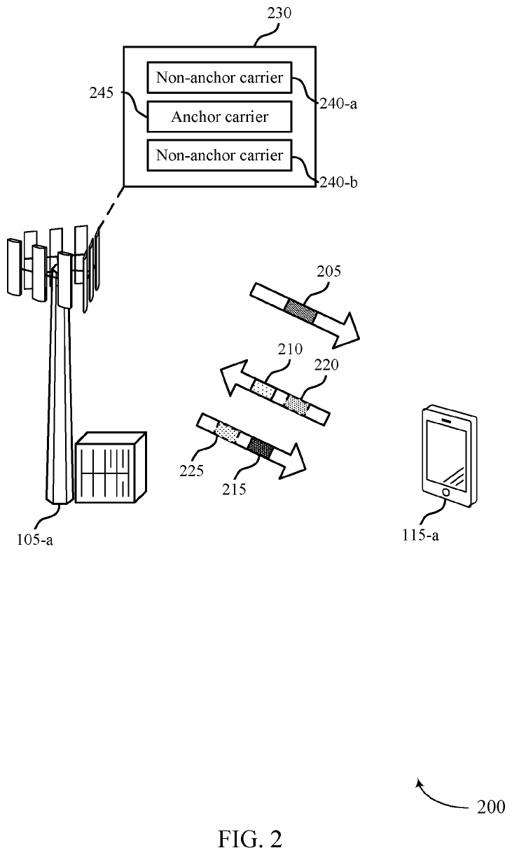

FIG. 2 illustrates an example of a wireless communications system 200 that supports carrier selection for downlink random access messages in accordance with aspects of the present disclosure. In some examples, wireless communications system 200 may implement or be implemented by one or more aspects of wireless communications system 100. For example, wireless communications system 200 may include a UE 115-a and a base station 105-a, which may be examples of a UE 115 and a base station 105 described with reference to FIG. 1.

Base station 105-a may include or support a flexible cell 230 (e.g., an elastic cell), which may represent a cell with a collection of multiple carriers. For example the flexible cell 230 may include any combination of carriers (e.g., a set of carriers) for FDD, TDD, or supplemental uplink (SUL) operations. For example, a simple flexible cell 230 may include a normal uplink (NUL) carrier and an SUL carrier, where a base station 105-a may dynamically schedule a UE 115-a to transmit on either the NUL carrier or the SUL carrier. The set of carriers on the flexible cell 230 may support flexible use of one or more spectra that may be re-used from LTE deployments, among other examples.

The carriers (e.g., the set of carriers) of the flexible cell 230 may include an anchor carrier 245, and one or more non-anchor carriers 240, where each of the carriers of the flexible cell 230 may be non-contiguous carriers. For example, the flexible cell 230 may include an anchor carrier 245, a non-anchor carrier 240-a, and a non-anchor carrier 240-b. Other examples of a flexible cell 230 may include any number of carriers (e.g., one anchor carrier 245 and one or more non-anchor carriers 240, such as three or more non-anchor carriers 240) without departing from the scope of the present disclosure.

A flexible cell 230 may be different (e.g., may be implemented differently) from a carrier aggregation configuration. For example, a carrier aggregation framework may support communication over a set of carriers in which the network (e.g., base station 105-a) separately configures multiple cells on the set of carriers, and indicates a carrier aggregation configuration to UE 115-a. In each cell of the carrier aggregation configuration, an uplink carrier may relate to a downlink carrier. Further, when establishing an RRC connection in a carrier aggregation configuration, random access procedures may be limited to be performed on a primary cell of the configuration.

A carrier aggregation configuration is different from a flexible cell 230, which may represent a single cell configured with multiple carriers. When establishing an RRC connection via a flexible cell 230, random access procedures may be performed via any of the multiple carriers. The carrier aggregation framework may further be associated with a higher signaling overhead and a complex cell management system (e.g., for separately configuring the multiple cells on the set of carriers), compared with the configuration of a flexible cell 230.

In some cases, downlink random access messages (e.g., on a physical downlink control channel (PDCCH), a physical downlink shared channel (PDSCH)) may be transmitted via the anchor carrier 245 of the flexible cell 230. The downlink random access messages may include transmissions of a downlink control channel (e.g., PDCCH) and a shared channel (e.g., PDSCH) for a message B (msgB) of a two-step random access procedure, or may include transmissions of a downlink control channel (e.g., PDCCH) for a message 2 (msg2), a message 3 (msg3), or a message 4 (msg4) of a four-step random access procedure, as well as a shared channel (e.g., PDSCH) for msg2 or msg4 of the four-step random access procedure.

Because multiple carriers (e.g., an anchor carrier 245 and up to N non-anchor carriers 240) may be available for communication on the flexible cell 230, UE 115-a may not be aware of which carrier is used for reception of one or more of the downlink random access messages, especially if such a carrier is not the anchor carrier 245 (e.g., a non-anchor carrier 240 is used for downlink transmissions). In some cases, the UE 115-a may default to using an anchor carrier of a flexible cell for communications during a RACH procedure.

The present disclosure provides techniques for indicating one or more carriers of a flexible cell 230, to be used for reception of one or more respective downlink random access messages. For example, base station 105-a may indicate, via system information 205, a carrier for reception of a downlink control channel (e.g., PDCCH) scheduling a second random access message 215 (e.g., msg2 or msgB). When initiating a random access procedure, UE 115-a may transmit, to base station 105-a, a first random access message 210 (e.g., an uplink random access message), such as a message 1 (msg1) for four-step random access or a message A (msgA) for two-step random access. UE 115-a may monitor for and receive the downlink control channel (e.g., PDCCH) scheduling the second random access message 215 via the carrier indicated in the system information 205.

In some cases, UE 115-a may receive the second random access message 215 via the same carrier as the associated downlink control channel, or via a different carrier that may be indicated in the system information or in the downlink control channel transmission. In a four-step random access procedure, a respective carrier of the flexible cell 230 for reception of a downlink control channel for retransmission of a third random access message 220 (e.g., msg3), for reception of a downlink control channel for a fourth random access message 225 (e.g., msg4), or for reception of the fourth random access message 225, may be indicated via the system information 205 or via a previous downlink random access message. In such cases, UE 115-a may receive the corresponding downlink random access message via the indicated carrier of the flexible cell 230.

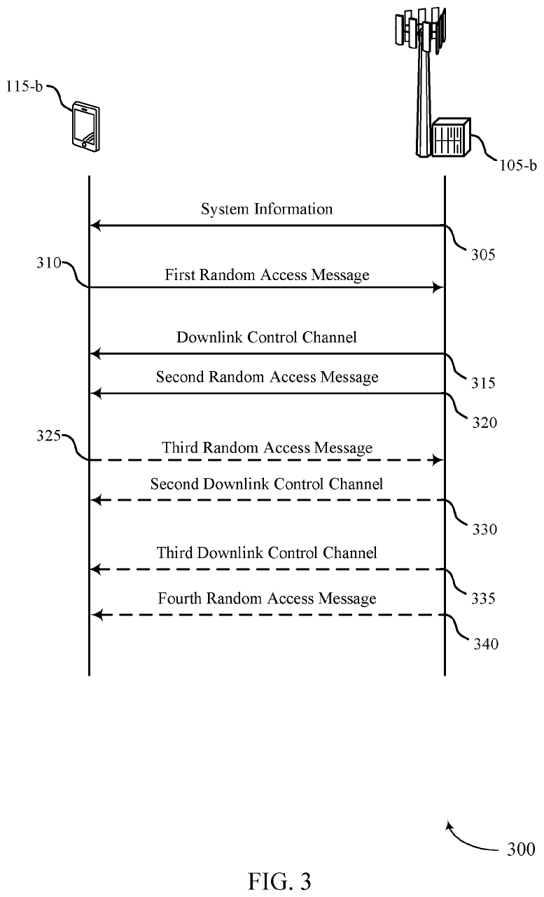

FIG. 3 illustrates an example of a process flow 300 that supports carrier selection for downlink random access messages in accordance with aspects of the present disclosure. In some examples, process flow 300 may implement or be implemented by one or more aspects of wireless communications system 100 or 200. For example, process flow 300 may be implemented by a base station 105-b and a UE 115-b, which may be examples of a base station 105 and a UE 115 described with reference to FIGS. 1 and 2.

In the following description of process flow 300, the operations may be performed in a different order than the order shown, or the operations performed by UE 115-b and base station 105-b may be performed in different orders or at different times. For example, some operations may also be left out of process flow 300, or other operations may be added to process flow 300. As another example, operations shown as performed in a single instance (e.g., a single transmission) may in some cases be performed as multiple instances (e.g., multiple transmissions) over some duration of time, or multiple transmissions may be combined into a single transmission instance. Although UE 115-b and base station 105-b are shown performing the operations of process flow 300, some aspects of some operations may also be performed by one or more other wireless devices.

Process flow 300 may illustrate a four-step random access procedure performed by UE 115-b and base station 105-b. The four-step random access procedure may include transmission of one or more messages, which may include msg1, msg2, msg3, msg4, and feedback (e.g., HARQ feedback) for msg4. The msg1 may be transmitted via a physical random access channel (PRACH), and may include a random access preamble. The msg2 may represent a random access response and may be scheduled via a downlink control channel (e.g., PDCCH) and may be transmitted via a downlink shared channel (e.g., PDSCH). The msg2 may include a timing advance, an uplink grant for msg3, and a radio network temporary identifier (RNTI) such as a temporary cell RNTI (TC-RNTI). The msg3 may be transmitted via an uplink shared channel (e.g., a physical uplink shared channel (PUSCH)) and may include a connection request (e.g., RRC connection request), a scheduling request, and a buffer status.

The msg4 include a contention resolution message, may be scheduled via a downlink control channel (e.g., PDCCH), and may be transmitted via a downlink shared channel (e.g., PDSCH). The feedback for msg4 may be transmitted via an uplink control channel (e.g., a physical uplink control channel (PUCCH)) and may include feedback indicating whether msg4 was received successfully by UE 115-b. For example, the feedback may include an acknowledgement (ACK) when msg4 is successfully received.

At 305, base station 105-b may transmit, to UE 115-b, system information for a cell (e.g., a flexible cell) that comprises an anchor carrier and one or more other carriers (e.g., non-anchor carriers). The system information may include an indication of a first other carrier of the one or more other carriers (e.g., non-anchor carriers) for receiving a downlink control channel (e.g., PDCCH) scheduling a second random access message (e.g., msg2). For example, the system information may indicate the first other carrier using reserved bits using a dedicated information element, or using an existing information element, among other examples.

If the system information does not include the indication of the first other carrier, UE 115-b may use the anchor carrier of the cell to receive the downlink control channel scheduling the second random access message. For example, if the network (e.g., base station 105-b) does not indicate, via the system information, a carrier for receiving the downlink control channel or the second random access message, or both, one or both of these communications (e.g., the communication(s) not indicated in the system information) may be received via the anchor carrier as a default option.

At 310, UE 115-b may transmit, to base station 105-b, a first random access message (e.g., msg1) for a random access procedure (e.g., the four-step random access procedure).

At 315, base station 105-b may transmit, to UE 115-b and in response to the first random access message, the downlink control channel scheduling the second random access message (e.g., a PDCCH scheduling msg2). For example, base station 105-b may transmit the downlink control channel via the first other carrier indicated in the system information. UE 115-b may receive the downlink control channel based on monitoring the first other carrier indicated in the system information.

At 320, base station 105-b may also transmit, to UE 115-b and in response to transmitting the downlink control channel scheduling the second random access message, the second random access message (e.g., msg2). In some cases, base station 105-b may transmit the second random access message via the first other carrier, based on transmitting the downlink control channel via the first other carrier. For example, the indication of the first other carrier in the system information may be applicable to both the downlink control channel and the second random access message (e.g., UE 115-b may receive the PDCCH and the PDSCH for msg2 via the same indicated carrier). In such cases, base station 105-b may transmit, and UE 115-b may receive, the second random access message via the first other carrier (e.g., based on UE 115-b monitoring the first other carrier for the second random access message).

In some cases, decoupling the carrier indication for the downlink control channel and the second random access message may increase flexibility (e.g., may increase PDCCH capacity). As such, a carrier for UE 115-b to receive the second random access message may be different from the first other carrier indicated for reception of the downlink control channel. For example, the system information may include the indication of the first other carrier for the downlink control channel, and may also include an indication of a second other carrier of the flexible cell for the second random access message. In another example, the downlink control channel scheduling the second random access message may include an indication of a second other carrier of the flexible cell for the second random access message. Based on the indication of the second other carrier, base station 105-b may transmit, and UE 115-b may receive, the second random access message via the second other carrier (e.g., based on UE 115-b monitoring the second other carrier for the second random access message).

In some cases, the system information or the downlink control channel may include an indication of the second other carrier whether or not the first other carrier is indicated. For example, in some cases, base station 105-b may not indicate the first other carrier via the system information, but may indicate the second other carrier via the system information or via the downlink control channel.

At 325, UE 115-b may transmit a third random access message (e.g., msg3) to base station 105-b in response to receiving the second random access message. For example, UE 115-b may transmit the third random access message via a shared uplink channel (e.g., PUSCH). In some cases, base station 105-b may schedule a retransmission of the third random access message, for example, if base station 105-b fails to receive or decode the third random access message, among other examples.

In such cases, at 330, base station 105-b may transmit, to UE 115-b, a second downlink control channel scheduling a retransmission of the third random access message (e.g., a PDCCH scheduling retransmission of msg3). In some cases, base station 105-b may transmit the second downlink control channel via the first other carrier, based on transmitting the downlink control channel via the first other carrier. For example, the second downlink control channel may be transmitted via a same carrier as the downlink control channel. In such cases, base station 105-b may transmit, and UE 115-b may receive, the second downlink control channel via the first other carrier (e.g., based on UE 115-b monitoring the first other carrier for the second downlink control channel).

In some cases, base station 105-b may transmit the second downlink control channel via the second other carrier, based on transmitting the second random access message via the second other carrier (e.g., whether or not the downlink control channel is transmitted via the first other carrier). For example, the second downlink control channel may be transmitted via a same carrier as the second random access message. In such cases, base station 105-b may transmit, and UE 115-b may receive, the second downlink control channel via the second other carrier (e.g., based on UE 115-b monitoring the second other carrier for the second downlink control channel).

In some cases, a carrier for UE 115-b to receive the second downlink control channel may be different from the first other carrier or the second other carrier. For example, the system information may include an indication of a third other carrier of the flexible cell for the second downlink control channel. In another example, the downlink control channel or the second random access message, or both, may include an indication of a third other carrier of the flexible cell for the second downlink control channel. Based on the indication of the third other carrier, base station 105-b may transmit, and UE 115-b may receive, the second downlink control channel via the third other carrier (e.g., based on UE 115-b monitoring the third other carrier for the second downlink control channel).

In some cases, the system information, the downlink control channel, or the second random access message may include an indication of the third other carrier whether or not the first other carrier or the second other carrier, or both, are indicated. For example, in some cases, base station 105-b may not indicate the first other carrier or the second other carrier, but may indicate the third other carrier via the system information, the downlink control channel, or the second random access message.

Based on receiving the second downlink control channel scheduling the third random access message, UE 115-b may retransmit the third random access message to base station 105-b.

At 335, base station 105-b may transmit, to UE 115-b a third downlink control channel scheduling a fourth random access message (e.g., a PDCCH scheduling msg4) in response to transmission of the third random access message by UE 115-b. In some cases, base station 105-b may transmit the third downlink control channel via the first other carrier of the flexible cell, based on transmitting the downlink control channel via the first other carrier. For example, the third downlink control channel may be transmitted via a same carrier as the downlink control channel. In such cases, base station 105-b may transmit, and UE 115-b may receive, the third downlink control channel via the first other carrier (e.g., based on UE 115-b monitoring the first other carrier for the third downlink control channel).

In some cases, base station 105-b may transmit the third downlink control channel via the second other carrier of the flexible cell, based on transmitting the second random access message via the second other carrier (e.g., whether or not the downlink control channel is transmitted via the first other carrier). For example, the third downlink control channel may be transmitted via a same carrier as the second random access message. In such cases, base station 105-b may transmit, and UE 115-b may receive, the third downlink control channel via the second other carrier (e.g., based on UE 115-b monitoring the second other carrier for the third downlink control channel).

In some cases, base station 105-b may transmit the third downlink control channel via the third other carrier of the flexible cell, based on transmitting the second downlink control channel via the third other carrier (e.g., whether or not the downlink control channel is transmitted via the first other carrier or the second random access message is transmitted via the second other carrier). For example, the third downlink control channel may be transmitted via a same carrier as the second downlink control channel. In such cases, base station 105-b may transmit, and UE 115-b may receive, the third downlink control channel via the third other carrier (e.g., based on UE 115-b monitoring the third other carrier for the third downlink control channel).

In some cases, a carrier for UE 115-b to receive the third downlink control channel may be different from the first other carrier, the second other carrier, or the third other carrier. For example, the system information may include an indication of a fourth other carrier of the flexible cell for the third downlink control channel. In another example, the downlink control channel, the second random access message, the second downlink control channel, or any combination thereof, may include an indication of a fourth other carrier of the flexible cell for the third downlink control channel. Based on the indication of the fourth other carrier, base station 105-b may transmit, and UE 115-b may receive, the third downlink control channel via the fourth other carrier (e.g., based on UE 115-b monitoring the fourth other carrier for the third downlink control channel).

In some cases, the system information, the downlink control channel, the second random access message, or the second downlink control channel may include an indication of the fourth other carrier whether or not the first other carrier, the second other carrier, or the third other carrier (e.g., or some combination thereof), are indicated. For example, in some cases, base station 105-b may not indicate the first other carrier, the second other carrier, or the third other carrier (e.g., or some combination thereof), but may indicate the fourth other carrier via the system information, the downlink control channel, the second random access message, or the second downlink control channel.

At 340, base station 105-b may transmit, to UE 115-b, a fourth random access message (e.g., msg4) in response to transmitting the third downlink control channel. In some cases, base station 105-b may transmit the fourth random access message via the first other carrier of the flexible cell, based on transmitting the downlink control channel via the first other carrier. For example, the fourth random access message may be transmitted via a same carrier as the downlink control channel. In such cases, base station 105-b may transmit, and UE 115-b may receive, the fourth random access message via the first other carrier (e.g., based on UE 115-b monitoring the first other carrier for the fourth random access message).

In some cases, base station 105-b may transmit the fourth random access message via the second other carrier of the flexible cell, based on transmitting the second random access message via the second other carrier (e.g., whether or not the downlink control channel is transmitted via the first other carrier). For example, the fourth random access message may be transmitted via a same carrier as the second random access message. In such cases, base station 105-b may transmit, and UE 115-b may receive, the fourth random access message via the second other carrier (e.g., based on UE 115-b monitoring the second other carrier for the fourth random access message).

In some cases, base station 105-b may transmit the fourth random access message via the third other carrier of the flexible cell, based on transmitting the second downlink control channel via the third other carrier (e.g., whether or not the downlink control channel is transmitted via the first other carrier or the second random access message is transmitted via the second other carrier). For example, the fourth random access message may be transmitted via a same carrier as the second downlink control channel. In such cases, base station 105-b may transmit, and UE 115-b may receive, the fourth random access message via the third other carrier (e.g., based on UE 115-b monitoring the third other carrier for the fourth random access message).

In some cases, base station 105-b may transmit the fourth random access message via the fourth other carrier of the flexible cell, based on transmitting the third downlink control channel via the fourth other carrier (e.g., whether or not the downlink control channel is transmitted via the first other carrier, the second random access message is transmitted via the second other carrier, or the second downlink control channel is transmitted via the third other carrier). For example, the fourth random access message may be transmitted via a same carrier as the third downlink control channel. In such cases, base station 105-b may transmit, and UE 115-b may receive, the fourth random access message via the fourth other carrier (e.g., based on UE 115-b monitoring the fourth other carrier for the fourth random access message).

In some cases, a carrier for UE 115-b to receive the fourth random access message may be different from the first other carrier, the second other carrier, the third other carrier, or the fourth other carrier. For example, the system information may include an indication of a fifth other carrier of the flexible cell for the fourth random access message. In another example, the downlink control channel, the second random access message, the second downlink control channel, the third downlink control channel, or any combination thereof, may include an indication of a fifth other carrier of the flexible cell for the fourth random access message. Based on the indication of the fifth other carrier, base station 105-b may transmit, and UE 115-b may receive, the fourth random access message via the fifth other carrier (e.g., based on UE 115-b monitoring the fifth other carrier for the fourth random access message).

In some cases, the system information, the downlink control channel, the second random access message, the second downlink control channel, or the third downlink control channel may include an indication of the fifth other carrier whether or not the first other carrier, the second other carrier, the third other carrier, the fourth other carrier (e.g., or some combination thereof), are indicated. For example, in some cases, base station 105-b may not indicate the first other carrier, the second other carrier, the third other carrier, or the fourth other carrier (e.g., or some combination thereof), but may indicate the fifth other carrier via the system information, the downlink control channel, the second random access message, the second downlink control channel, or the third downlink control channel.

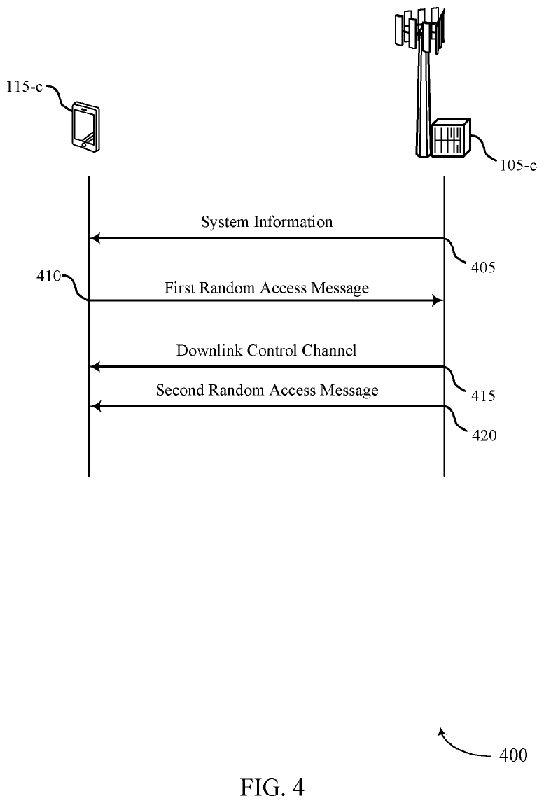

FIG. 4 illustrates an example of a process flow 400 that supports carrier selection for downlink random access messages in accordance with aspects of the present disclosure. In some examples, process flow 400 may implement or be implemented by one or more aspects of wireless communications system 100 or 200. For example, process flow 400 may be implemented by a base station 105-c and a UE 115-c, which may be examples of a base station 105 and a UE 115 described with reference to FIGS. 1-3.

In the following description of process flow 400, the operations may be performed in a different order than the order shown, or the operations performed by UE 115-c and base station 105-c may be performed in different orders or at different times. For example, some operations may also be left out of process flow 400, or other operations may be added to process flow 400. As another example, operations shown as performed in a single instance (e.g., a single transmission) may in some cases be performed as multiple instances (e.g., multiple transmissions) over some duration of time, or multiple transmissions may be combined into a single transmission instance. Although UE 115-c and base station 105-c are shown performing the operations of process flow 400, some aspects of some operations may also be performed by one or more other wireless devices.

Process flow 400 may illustrate a two-step random access procedure performed by UE 115-c and base station 105-c. The two-step random access procedure may include transmission of one or more messages, which may include msgA, msgB, and feedback (e.g., HARQ feedback) for msgB. The msgA may include a preamble (e.g., msgA preamble), which be transmitted via a PRACH, and a payload (e.g., msgA payload), which may be transmitted via an uplink shared channel (e.g., PUSCH). The msgA payload (e.g., PUSCH transmission) may include at least similar contents to msg3 from a four-step random access procedure, such as an RRC request, a buffer state report, and so on. The msgA payload may also include data (e.g., data related to the random access procedure).

The msgB may represent a random access response and may be scheduled via a downlink control channel (e.g., PDCCH) and may be transmitted via a downlink shared channel (e.g., PDSCH). The msgB may include at least similar information to msg2 and msg4 from a four-step random access procedure (e.g., a timing advance, a RNTI, contention resolution information). The feedback for msgB may be transmitted via an uplink control channel (e.g., a PUCCH) and may include feedback indicating whether msgB was received successfully by UE 115-c. For example, the feedback may include an ACK when msgB is successfully received.

At 405, base station 105-c may transmit, to UE 115-c, system information for a cell (e.g., a flexible cell) that comprises an anchor carrier and one or more other carriers (e.g., non-anchor carriers). The system information may include an indication of a first other carrier of the one or more other carriers (e.g., non-anchor carriers) for receiving a downlink control channel (e.g., PDCCH) scheduling a second random access message (e.g., msgB). For example, the system information may indicate the first other carrier using reserved bits using a dedicated information element, or using an existing information element, among other examples.

If the system information does not include the indication of the first other carrier, UE 115-c may use the anchor carrier of the cell to receive the downlink control channel scheduling the second random access message. For example, if the network (e.g., base station 105-c) does not indicate, via the system information, a carrier for receiving the downlink control channel or the second random access message, or both, one or both of these communications (e.g., the communication(s) not indicated in the system information) may be received via the anchor carrier as a default option.

At 410, UE 115-c may transmit, to base station 105-c, a first random access message (e.g., msgA, such as the preamble and the payload for msgA) for a random access procedure (e.g., the two-step random access procedure).

At 415, base station 105-c may transmit, to UE 115-c and in response to the first random access message, the downlink control channel scheduling the second random access message (e.g., a PDCCH scheduling msgB). For example, base station 105-c may transmit the downlink control channel via the first other carrier indicated in the system information. UE 115-c may receive the downlink control channel based on monitoring the first other carrier indicated in the system information.

At 420, base station 105-c may also transmit, to UE 115-c and in response to transmitting the downlink control channel scheduling the second random access message, the second random access message (e.g., msgB). In some cases, base station 105-c may transmit the second random access message via the first other carrier, based on transmitting the downlink control channel via the first other carrier. For example, the indication of the first other carrier in the system information may be applicable to both the downlink control channel and the second random access message (e.g., UE 115-c may receive the PDCCH and the PDSCH for msgB via the same indicated carrier). In such cases, base station 105-c may transmit, and UE 115-c may receive, the second random access message via the first other carrier (e.g., based on UE 115-c monitoring the first other carrier for the second random access message).

In some cases, decoupling the carrier indication for the downlink control channel and the second random access message may increase flexibility (e.g., may increase PDCCH capacity). As such, a carrier for UE 115-c to receive the second random access message may be different from the first other carrier indicated for reception of the downlink control channel. For example, the system information may include the indication of the first other carrier for the downlink control channel, and may also include an indication of a second other carrier of the flexible cell for the second random access message. In another example, the downlink control channel scheduling the second random access message may include an indication of a second other carrier of the flexible cell for the second random access message. Based on the indication of the second other carrier, base station 105-c may transmit, and UE 115-c may receive, the second random access message via the second other carrier (e.g., based on UE 115-c monitoring the second other carrier for the second random access message).

In some cases, the system information or the downlink control channel may include an indication of the second other carrier whether or not the first other carrier is indicated. For example, in some cases, base station 105-c may not indicate the first other carrier via the system information, but may indicate the second other carrier via the system information or via the downlink control channel.

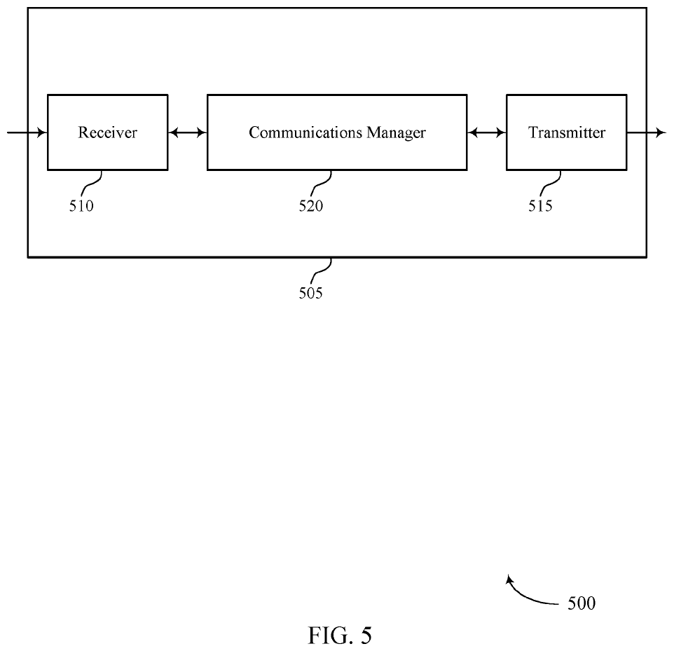

FIG. 5 shows a block diagram 500 of a device 505 that supports carrier selection for downlink random access messages in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to carrier selection for downlink random access messages). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to carrier selection for downlink random access messages). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of carrier selection for downlink random access messages as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, from a base station, system information for a cell that includes an anchor carrier and one or more other carriers, the system information including an indication of a first other carrier of the one or more other carriers for receiving a downlink control channel scheduling a second random access message. The communications manager 520 may be configured as or otherwise support a means for transmitting a first random access message for a random access procedure. The communications manager 520 may be configured as or otherwise support a means for receiving, in response to the first random access message and via the first other carrier, the downlink control channel scheduling the second random access message.

The actions performed by the communications manager 520, among other examples herein, may be implemented to realize one or more potential advantages. For example, communications manager 520 may increase available battery power and communication quality at a wireless device (e.g., a UE 115) by supporting an indication of a carrier of a flexible cell for reception of a downlink random access message, which may increase communication quality at the wireless device by providing transmission diversity. The associated increase in communication quality may result in increased link performance and decreased overhead based on receiving the downlink random access message. Accordingly, communications manager 520 may save power and increase battery life at a wireless device (e.g., a UE 115) by strategically increasing a quality of communications at a wireless device (e.g., a UE 115).

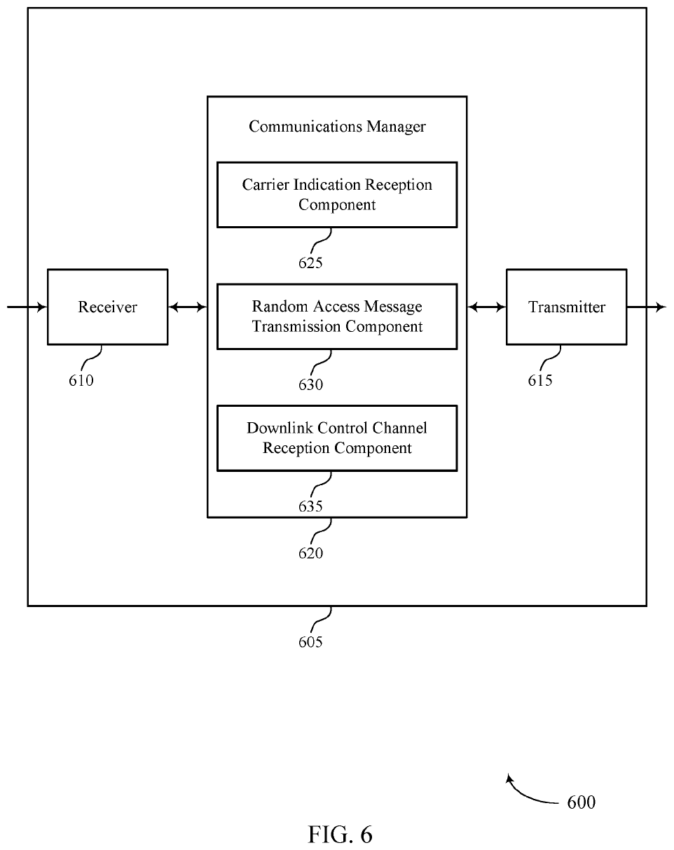

FIG. 6 shows a block diagram 600 of a device 605 that supports carrier selection for downlink random access messages in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to carrier selection for downlink random access messages). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to carrier selection for downlink random access messages). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of carrier selection for downlink random access messages as described herein. For example, the communications manager 620 may include a carrier indication reception component 625, a random access message transmission component 630, a downlink control channel reception component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The carrier indication reception component 625 may be configured as or otherwise support a means for receiving, from a base station, system information for a cell that includes an anchor carrier and one or more other carriers, the system information including an indication of a first other carrier of the one or more other carriers for receiving a downlink control channel scheduling a second random access message. The random access message transmission component 630 may be configured as or otherwise support a means for transmitting a first random access message for a random access procedure. The downlink control channel reception component 635 may be configured as or otherwise support a means for receiving, in response to the first random access message and via the first other carrier, the downlink control channel scheduling the second random access message.

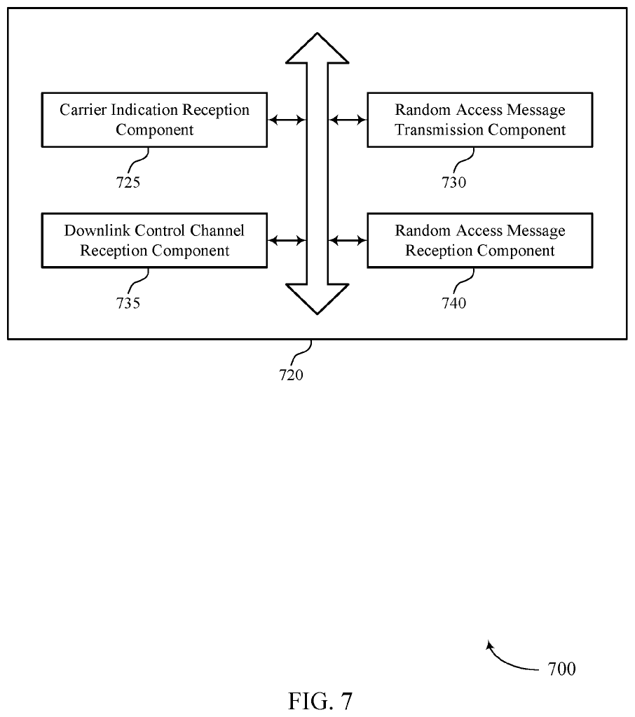

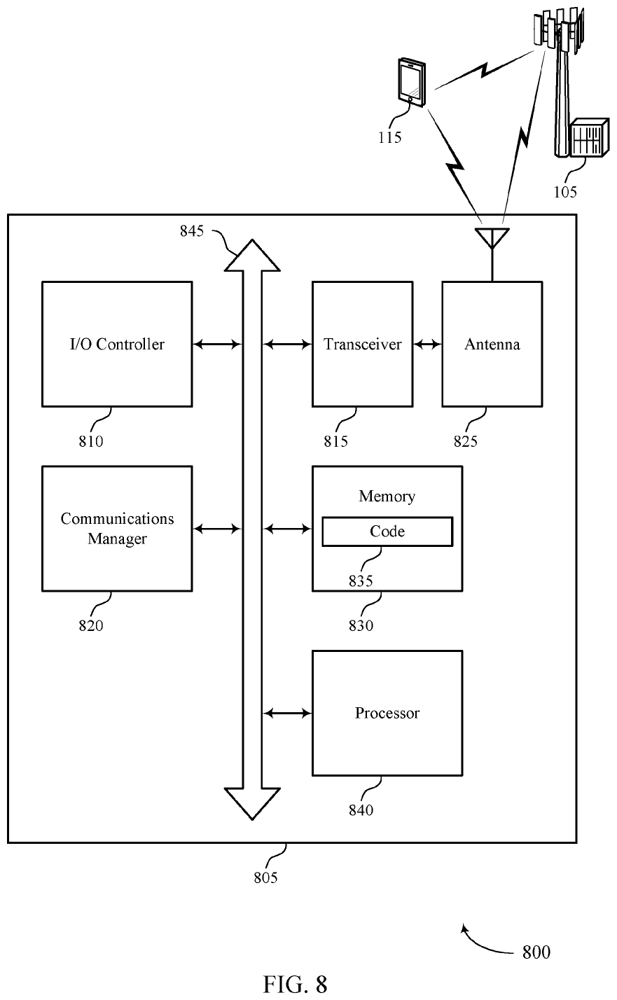

A processor of a wireless device (e.g., controlling the receiver 610, the transmitter 615, or the transceiver 815 as described with reference to FIG. 8) may increase available battery power and communication quality. The increased communication quality may increase available battery power and throughput (e.g., via implementation of system components described with reference to FIG. 7) compared to other systems and techniques, for example, that do not support an indication of a carrier of a flexible cell for reception of a downlink random access message. Further, the processor of the wireless device may identify one or more aspects of the carrier indicated for the reception of the downlink random access message, which may result in increased communication quality, as well as save power and increase battery life at the wireless device (e.g., by strategically supporting increased transmission diversity), among other benefits.

FIG. 7 shows a block diagram 700 of a communications manager 720 that supports carrier selection for downlink random access messages in accordance with aspects of the present disclosure. The communications manager 720 may be an example of aspects of a communications manager 520, a communications manager 620, or both, as described herein. The communications manager 720, or various components thereof, may be an example of means for performing various aspects of carrier selection for downlink random access messages as described herein. For example, the communications manager 720 may include a carrier indication reception component 725, a random access message transmission component 730, a downlink control channel reception component 735, a random access message reception component 740, or any combination thereof. Each of these components may communicate, directly or indirectly, with one another (e.g., via one or more buses).

The communications manager 720 may support wireless communication at a UE in accordance with examples as disclosed herein. The carrier indication reception component 725 may be configured as or otherwise support a means for receiving, from a base station, system information for a cell that includes an anchor carrier and one or more other carriers, the system information including an indication of a first other carrier of the one or more other carriers for receiving a downlink control channel scheduling a second random access message. The random access message transmission component 730 may be configured as or otherwise support a means for transmitting a first random access message for a random access procedure. The downlink control channel reception component 735 may be configured as or otherwise support a means for receiving, in response to the first random access message and via the first other carrier, the downlink control channel scheduling the second random access message.

In some examples, the random access message reception component 740 may be configured as or otherwise support a means for receiving the second random access message via the first other carrier based on the indication of the first other carrier in the system information and in response to receiving the downlink control channel scheduling the second random access message.

In some examples, the carrier indication reception component 725 may be configured as or otherwise support a means for receiving, via the system information, an indication of a second other carrier for receiving the second random access message. In some examples, the random access message reception component 740 may be configured as or otherwise support a means for receiving the second random access message via the second other carrier based on the indication of the second other carrier in the system information and in response to receiving the downlink control channel scheduling the second random access message.

In some examples, the carrier indication reception component 725 may be configured as or otherwise support a means for receiving, via the downlink control channel, an indication of a second other carrier for receiving the second random access message. In some examples, the random access message reception component 740 may be configured as or otherwise support a means for receiving the second random access message via the second other carrier based on the indication of the second other carrier in the downlink control channel and in response to receiving the downlink control channel scheduling the second random access message.

In some examples, the downlink control channel reception component 735 may be configured as or otherwise support a means for receiving, via the first other carrier, a second downlink control channel scheduling a third random access message based on the indication of the first other carrier in the system information. In some examples, the downlink control channel reception component 735 may be configured as or otherwise support a means for receiving, via a second other carrier, a second downlink control channel scheduling a third random access message based on receiving the second random access message via the second other carrier.

In some examples, the carrier indication reception component 725 may be configured as or otherwise support a means for receiving an indication of a third other carrier for a second downlink control channel scheduling a third random access message, where the indication of the third other carrier is received via the system information, the downlink control channel, the second random access message, or any combination thereof. In some examples, the downlink control channel reception component 735 may be configured as or otherwise support a means for receiving, via the third other carrier, the second downlink control channel based on the indication of the third other carrier.

In some examples, the downlink control channel reception component 735 may be configured as or otherwise support a means for receiving, via the first other carrier, a third downlink control channel scheduling a fourth random access message based on the indication of the first other carrier in the system information. In some examples, the downlink control channel reception component 735 may be configured as or otherwise support a means for receiving, via a second other carrier, a third downlink control channel scheduling a fourth random access message based on receiving the second random access message via the second other carrier. In some examples, the downlink control channel reception component 735 may be configured as or otherwise support a means for receiving, via a third other carrier, a third downlink control channel scheduling a fourth random access message based on receiving, via the third other carrier, a second downlink control channel scheduling a third random access message.

In some examples, the carrier indication reception component 725 may be configured as or otherwise support a means for receiving an indication of a fourth other carrier for a third downlink control channel scheduling a fourth random access message, where the indication of the fourth other carrier is received via the system information, the downlink control channel, the second random access message, a second downlink control channel scheduling a third random access message, or any combination thereof. In some examples, the downlink control channel reception component 735 may be configured as or otherwise support a means for receiving, via the fourth other carrier, the third downlink control channel based on the indication of the fourth other carrier.

In some examples, the random access message reception component 740 may be configured as or otherwise support a means for receiving, via the first other carrier, a fourth random access message based on the indication of the first other carrier in the system information. In some examples, the random access message reception component 740 may be configured as or otherwise support a means for receiving, via a second other carrier, a fourth random access message based on receiving the second random access message via the second other carrier.

In some examples, the random access message reception component 740 may be configured as or otherwise support a means for receiving, via a third other carrier, a fourth random access message based on receiving, via the third other carrier, a second downlink control channel scheduling a third random access message. In some examples, the random access message reception component 740 may be configured as or otherwise support a means for receiving, via a fourth other carrier, a fourth random access message based on receiving, via the fourth other carrier, a third downlink control channel scheduling the fourth random access message.

In some examples, the carrier indication reception component 725 may be configured as or otherwise support a means for receiving an indication of a fifth other carrier for a fourth random access message, where the indication of the fifth other carrier is received via the system information, the downlink control channel, the second random access message, a second downlink control channel scheduling a third random access message, a third downlink control channel scheduling the fourth random access message, or any combination thereof. In some examples, the random access message reception component 740 may be configured as or otherwise support a means for receiving, via the fifth other carrier, the fourth random access message based on the indication of the fifth other carrier.

In some examples, the cell includes a flexible cell that includes a set of non-aggregated carriers, the set of non-aggregated carriers including the anchor carrier. In some examples, the one or more other carriers and the one or more other carriers includes one or more non-anchor carriers. In some examples, the second random access message is a msg2 and the random access procedure is a four-step random access procedure or the second random access message is a msgB and the random access procedure is a two-step random access procedure.

FIG. 8 shows a diagram of a system 800 including a device 805 that supports carrier selection for downlink random access messages in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting carrier selection for downlink random access messages). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a base station, system information for a cell that includes an anchor carrier and one or more other carriers, the system information including an indication of a first other carrier of the one or more other carriers for receiving a downlink control channel scheduling a second random access message. The communications manager 820 may be configured as or otherwise support a means for transmitting a first random access message for a random access procedure. The communications manager 820 may be configured as or otherwise support a means for receiving, in response to the first random access message and via the first other carrier, the downlink control channel scheduling the second random access message.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of carrier selection for downlink random access messages as described herein, or the processor 840 and the memory 830 may be otherwise configured to perform or support such operations.

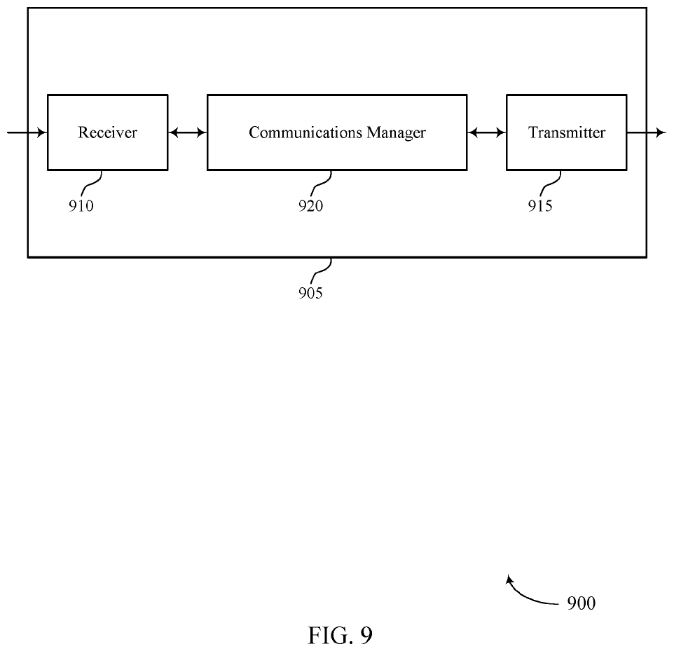

FIG. 9 shows a block diagram 900 of a device 905 that supports carrier selection for downlink random access messages in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to carrier selection for downlink random access messages). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to carrier selection for downlink random access messages). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of carrier selection for downlink random access messages as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for transmitting, to a UE, system information for a cell that includes an anchor carrier and one or more other carriers, the system information including an indication of a first other carrier of the one or more other carriers for transmitting a downlink control channel scheduling a second random access message. The communications manager 920 may be configured as or otherwise support a means for receiving, from the UE, a first random access message for a random access procedure. The communications manager 920 may be configured as or otherwise support a means for transmitting, in response to the first random access message and via the first other carrier, the downlink control channel scheduling the second random access message.

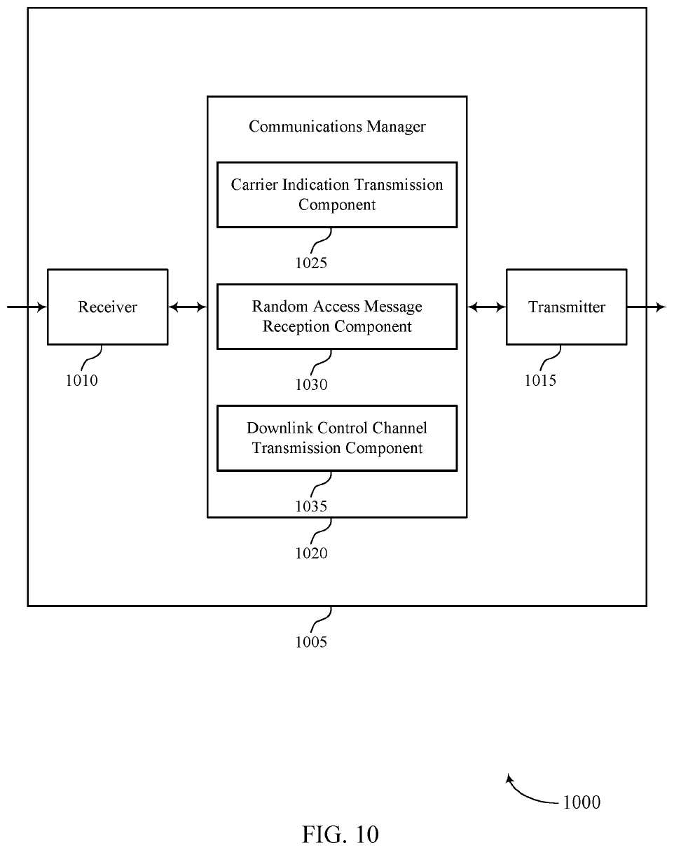

FIG. 10 shows a block diagram 1000 of a device 1005 that supports carrier selection for downlink random access messages in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to carrier selection for downlink random access messages). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to carrier selection for downlink random access messages). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of carrier selection for downlink random access messages as described herein. For example, the communications manager 1020 may include a carrier indication transmission component 1025, a random access message reception component 1030, a downlink control channel transmission component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The carrier indication transmission component 1025 may be configured as or otherwise support a means for transmitting, to a UE, system information for a cell that includes an anchor carrier and one or more other carriers, the system information including an indication of a first other carrier of the one or more other carriers for transmitting a downlink control channel scheduling a second random access message. The random access message reception component 1030 may be configured as or otherwise support a means for receiving, from the UE, a first random access message for a random access procedure. The downlink control channel transmission component 1035 may be configured as or otherwise support a means for transmitting, in response to the first random access message and via the first other carrier, the downlink control channel scheduling the second random access message.

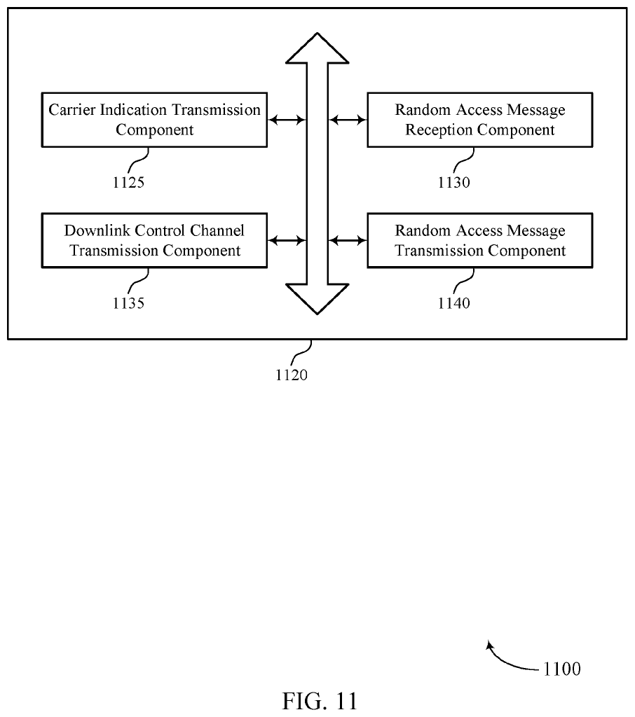

FIG. 11 shows a block diagram 1100 of a communications manager 1120 that supports carrier selection for downlink random access messages in accordance with aspects of the present disclosure. The communications manager 1120 may be an example of aspects of a communications manager 920, a communications manager 1020, or both, as described herein. The communications manager 1120, or various components thereof, may be an example of means for performing various aspects of carrier selection for downlink random access messages as described herein. For example, the communications manager 1120 may include a carrier indication transmission component 1125, a random access message reception component 1130, a downlink control channel transmission component 1135, a random access message transmission component 1140, or any combination thereof. Each of these components may communicate, directly or indirectly, with one another (e.g., via one or more buses).

The communications manager 1120 may support wireless communication at a base station in accordance with examples as disclosed herein. The carrier indication transmission component 1125 may be configured as or otherwise support a means for transmitting, to a UE, system information for a cell that includes an anchor carrier and one or more other carriers, the system information including an indication of a first other carrier of the one or more other carriers for transmitting a downlink control channel scheduling a second random access message. The random access message reception component 1130 may be configured as or otherwise support a means for receiving, from the UE, a first random access message for a random access procedure. The downlink control channel transmission component 1135 may be configured as or otherwise support a means for transmitting, in response to the first random access message and via the first other carrier, the downlink control channel scheduling the second random access message.

In some examples, the random access message transmission component 1140 may be configured as or otherwise support a means for transmitting the second random access message via the first other carrier based on the indication of the first other carrier in the system information and in response to transmitting the downlink control channel scheduling the second random access message.

In some examples, the carrier indication transmission component 1125 may be configured as or otherwise support a means for transmitting, via the system information, an indication of a second other carrier for transmitting the second random access message. In some examples, the random access message transmission component 1140 may be configured as or otherwise support a means for transmitting the second random access message via the second other carrier based on the indication of the second other carrier in the system information and in response to transmitting the downlink control channel scheduling the second random access message.

In some examples, the carrier indication transmission component 1125 may be configured as or otherwise support a means for transmitting, via the downlink control channel, an indication of a second other carrier for transmitting the second random access message. In some examples, the random access message transmission component 1140 may be configured as or otherwise support a means for transmitting the second random access message via the second other carrier based on the indication of the second other carrier in the downlink control channel and in response to transmitting the downlink control channel scheduling the second random access message.

In some examples, the downlink control channel transmission component 1135 may be configured as or otherwise support a means for transmitting, via the first other carrier, a second downlink control channel scheduling a third random access message based on the indication of the first other carrier in the system information. In some examples, the downlink control channel transmission component 1135 may be configured as or otherwise support a means for transmitting, via a second other carrier, a second downlink control channel scheduling a third random access message based on transmitting the second random access message via the second other carrier.

In some examples, the carrier indication transmission component 1125 may be configured as or otherwise support a means for transmitting an indication of a third other carrier for a second downlink control channel scheduling a third random access message, where the indication of the third other carrier is transmitted via the system information, the downlink control channel, the second random access message, or any combination thereof. In some examples, the downlink control channel transmission component 1135 may be configured as or otherwise support a means for transmitting, via the third other carrier, the second downlink control channel based on the indication of the third other carrier.

In some examples, the downlink control channel transmission component 1135 may be configured as or otherwise support a means for transmitting, via the first other carrier, a third downlink control channel scheduling a fourth random access message based on the indication of the first other carrier in the system information. In some examples, the downlink control channel transmission component 1135 may be configured as or otherwise support a means for transmitting, via a second other carrier, a third downlink control channel scheduling a fourth random access message based on transmitting the second random access message via the second other carrier. In some examples, the downlink control channel transmission component 1135 may be configured as or otherwise support a means for transmitting, via a third other carrier, a third downlink control channel scheduling a fourth random access message based on transmitting, via the third other carrier, a second downlink control channel scheduling a third random access message.

In some examples, the carrier indication transmission component 1125 may be configured as or otherwise support a means for transmitting an indication of a fourth other carrier for a third downlink control channel scheduling a fourth random access message, where the indication of the fourth other carrier is transmitted via the system information, the downlink control channel, the second random access message, a second downlink control channel scheduling a third random access message, or any combination thereof. In some examples, the downlink control channel transmission component 1135 may be configured as or otherwise support a means for transmitting, via the fourth other carrier, the third downlink control channel based on the indication of the fourth other carrier.

In some examples, the random access message transmission component 1140 may be configured as or otherwise support a means for transmitting, via the first other carrier, a fourth random access message based on the indication of the first other carrier in the system information. In some examples, the random access message transmission component 1140 may be configured as or otherwise support a means for transmitting, via a second other carrier, a fourth random access message based on transmitting the second random access message via the second other carrier.

In some examples, the random access message transmission component 1140 may be configured as or otherwise support a means for transmitting, via a third other carrier, a fourth random access message based on transmitting, via the third other carrier, a second downlink control channel scheduling a third random access message. In some examples, the random access message transmission component 1140 may be configured as or otherwise support a means for transmitting, via a fourth other carrier, a fourth random access message based on transmitting, via the fourth other carrier, a third downlink control channel scheduling the fourth random access message.

In some examples, the carrier indication transmission component 1125 may be configured as or otherwise support a means for transmitting an indication of a fifth other carrier for a fourth random access message, where the indication of the fifth other carrier is transmitted via the system information, the downlink control channel, the second random access message, a second downlink control channel scheduling a third random access message, a third downlink control channel scheduling the fourth random access message, or any combination thereof. In some examples, the random access message transmission component 1140 may be configured as or otherwise support a means for transmitting, via the fifth other carrier, the fourth random access message based on the indication of the fifth other carrier.

In some examples, the cell includes a flexible cell that includes a set of non-aggregated carriers, the set of non-aggregated carriers including the anchor carrier and the one or more other carriers. In some examples, the one or more other carriers includes one or more non-anchor carriers. In some examples, the second random access message is a msg2 and the random access procedure is a four-step random access procedure or the second random access message is a msgB and the random access procedure is a two-step random access procedure.

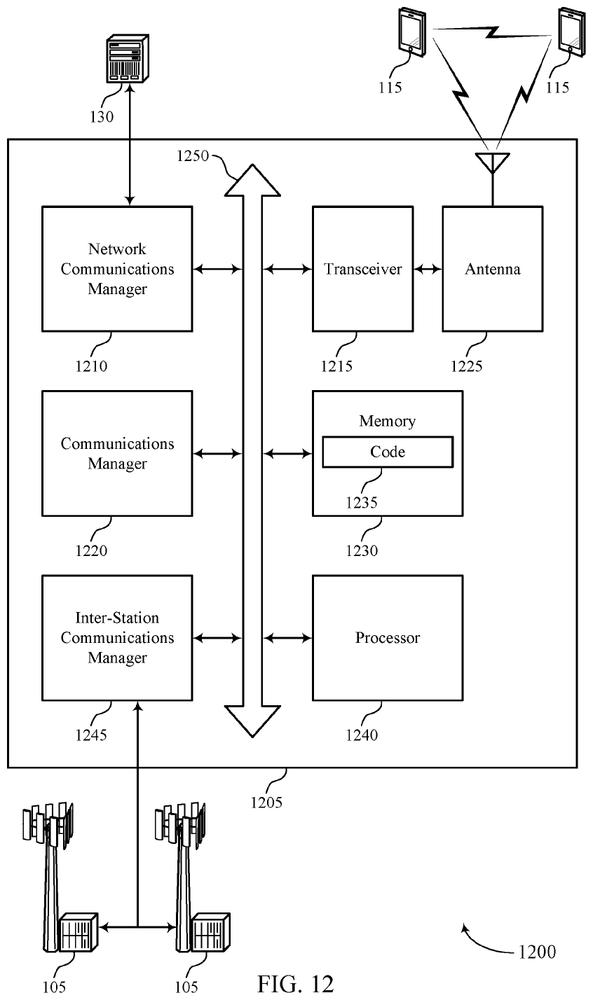

FIG. 12 shows a diagram of a system 1200 including a device 1205 that supports carrier selection for downlink random access messages in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting carrier selection for downlink random access messages). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for transmitting, to a UE, system information for a cell that includes an anchor carrier and one or more other carriers, the system information including an indication of a first other carrier of the one or more other carriers for transmitting a downlink control channel scheduling a second random access message. The communications manager 1220 may be configured as or otherwise support a means for receiving, from the UE, a first random access message for a random access procedure. The communications manager 1220 may be configured as or otherwise support a means for transmitting, in response to the first random access message and via the first other carrier, the downlink control channel scheduling the second random access message.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of carrier selection for downlink random access messages as described herein, or the processor 1240 and the memory 1230 may be otherwise configured to perform or support such operations.

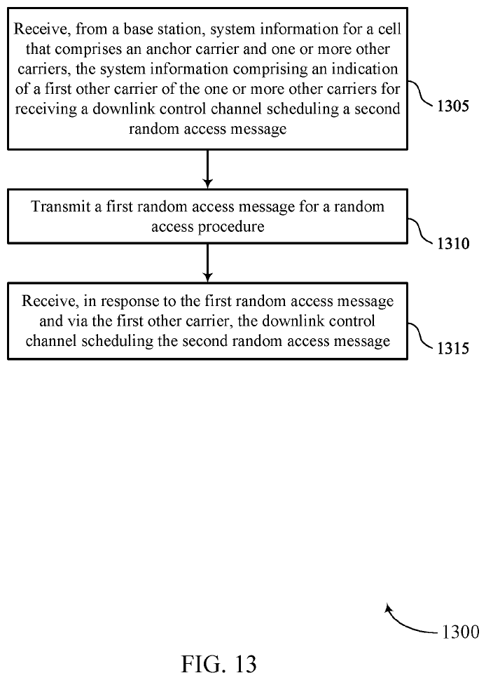

FIG. 13 shows a flowchart illustrating a method 1300 that supports carrier selection for downlink random access messages in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, system information for a cell that includes an anchor carrier and one or more other carriers, the system information including an indication of a first other carrier of the one or more other carriers for receiving a downlink control channel scheduling a second random access message. The operations of 1305 may be performed in accordance with examples as disclosed herein. In some examples, aspects of the operations of 1305 may be performed by a carrier indication reception component 725 as described with reference to FIG. 7.

At 1310, the method may include transmitting a first random access message for a random access procedure. The operations of 1310 may be performed in accordance with examples as disclosed herein. In some examples, aspects of the operations of 1310 may be performed by a random access message transmission component 730 as described with reference to FIG. 7.

At 1315, the method may include receiving, in response to the first random access message and via the first other carrier, the downlink control channel scheduling the second random access message. The operations of 1315 may be performed in accordance with examples as disclosed herein. In some examples, aspects of the operations of 1315 may be performed by a downlink control channel reception component 735 as described with reference to FIG. 7.

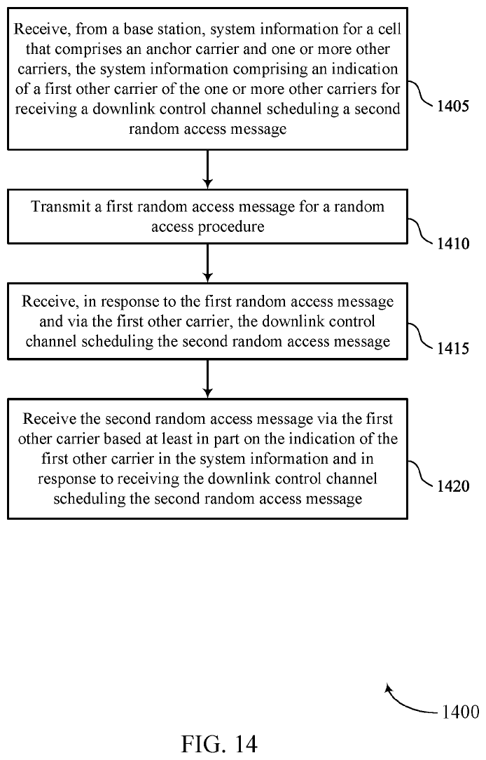

FIG. 14 shows a flowchart illustrating a method 1400 that supports carrier selection for downlink random access messages in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, system information for a cell that includes an anchor carrier and one or more other carriers, the system information including an indication of a first other carrier of the one or more other carriers for receiving a downlink control channel scheduling a second random access message. The operations of 1405 may be performed in accordance with examples as disclosed herein. In some examples, aspects of the operations of 1405 may be performed by a carrier indication reception component 725 as described with reference to FIG. 7.

At 1410, the method may include transmitting a first random access message for a random access procedure. The operations of 1410 may be performed in accordance with examples as disclosed herein. In some examples, aspects of the operations of 1410 may be performed by a random access message transmission component 730 as described with reference to FIG. 7.

At 1415, the method may include receiving, in response to the first random access message and via the first other carrier, the downlink control channel scheduling the second random access message. The operations of 1415 may be performed in accordance with examples as disclosed herein. In some examples, aspects of the operations of 1415 may be performed by a downlink control channel reception component 735 as described with reference to FIG. 7.

At 1420, the method may include receiving the second random access message via the first other carrier based on the indication of the first other carrier in the system information and in response to receiving the downlink control channel scheduling the second random access message. The operations of 1420 may be performed in accordance with examples as disclosed herein. In some examples, aspects of the operations of 1420 may be performed by a random access message reception component 740 as described with reference to FIG. 7.

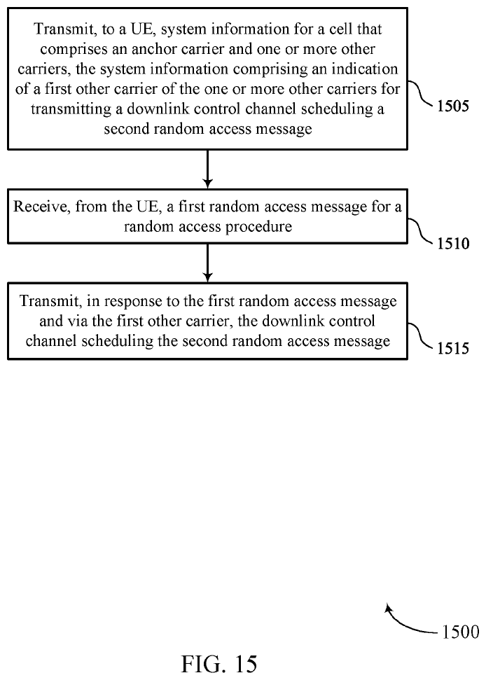

FIG. 15 shows a flowchart illustrating a method 1500 that supports carrier selection for downlink random access messages in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, system information for a cell that includes an anchor carrier and one or more other carriers, the system information including an indication of a first other carrier of the one or more other carriers for transmitting a downlink control channel scheduling a second random access message. The operations of 1505 may be performed in accordance with examples as disclosed herein. In some examples, aspects of the operations of 1505 may be performed by a carrier indication transmission component 1125 as described with reference to FIG. 11.

At 1510, the method may include receiving, from the UE, a first random access message for a random access procedure. The operations of 1510 may be performed in accordance with examples as disclosed herein. In some examples, aspects of the operations of 1510 may be performed by a random access message reception component 1130 as described with reference to FIG. 11.

At 1515, the method may include transmitting, in response to the first random access message and via the first other carrier, the downlink control channel scheduling the second random access message. The operations of 1515 may be performed in accordance with examples as disclosed herein. In some examples, aspects of the operations of 1515 may be performed by a downlink control channel transmission component 1135 as described with reference to FIG. 11.

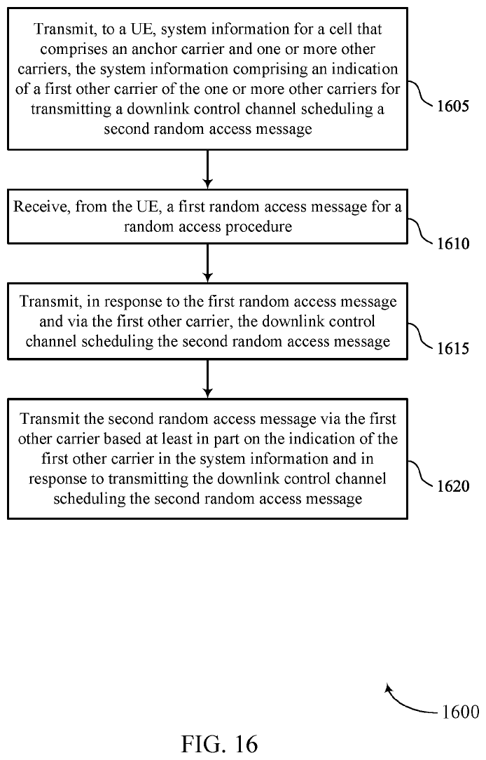

FIG. 16 shows a flowchart illustrating a method 1600 that supports carrier selection for downlink random access messages in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, system information for a cell that includes an anchor carrier and one or more other carriers, the system information including an indication of a first other carrier of the one or more other carriers for transmitting a downlink control channel scheduling a second random access message. The operations of 1605 may be performed in accordance with examples as disclosed herein. In some examples, aspects of the operations of 1605 may be performed by a carrier indication transmission component 1125 as described with reference to FIG. 11.

At 1610, the method may include receiving, from the UE, a first random access message for a random access procedure. The operations of 1610 may be performed in accordance with examples as disclosed herein. In some examples, aspects of the operations of 1610 may be performed by a random access message reception component 1130 as described with reference to FIG. 11.

At 1615, the method may include transmitting, in response to the first random access message and via the first other carrier, the downlink control channel scheduling the second random access message. The operations of 1615 may be performed in accordance with examples as disclosed herein. In some examples, aspects of the operations of 1615 may be performed by a downlink control channel transmission component 1135 as described with reference to FIG. 11.

At 1620, the method may include transmitting the second random access message via the first other carrier based on the indication of the first other carrier in the system information and in response to transmitting the downlink control channel scheduling the second random access message. The operations of 1620 may be performed in accordance with examples as disclosed herein. In some examples, aspects of the operations of 1620 may be performed by a random access message transmission component 1140 as described with reference to FIG. 11.

The following provides an overview of aspects of the present disclosure:

Aspect 1: A method for wireless communication at a UE, comprising: receiving, from a base station, system information for a cell that comprises an anchor carrier and one or more other carriers, the system information comprising an indication of a first other carrier of the one or more other carriers for receiving a downlink control channel scheduling a second random access message; transmitting a first random access message for a random access procedure; and receiving, in response to the first random access message and via the first other carrier, the downlink control channel scheduling the second random access message.

Aspect 2: The method of aspect 1, further comprising: receiving the second random access message via the first other carrier based at least in part on the indication of the first other carrier in the system information and in response to receiving the downlink control channel scheduling the second random access message.

Aspect 3: The method of aspect 1, further comprising: receiving, via the system information, an indication of a second other carrier for receiving the second random access message; and receiving the second random access message via the second other carrier based at least in part on the indication of the second other carrier in the system information and in response to receiving the downlink control channel scheduling the second random access message.

Aspect 4: The method of aspect 1, further comprising: receiving, via the downlink control channel, an indication of a second other carrier for receiving the second random access message; and receiving the second random access message via the second other carrier based at least in part on the indication of the second other carrier in the downlink control channel and in response to receiving the downlink control channel scheduling the second random access message.

Aspect 5: The method of any of aspects 1 through 4, further comprising: receiving, via the first other carrier, a second downlink control channel scheduling a third random access message based at least in part on the indication of the first other carrier in the system information.

Aspect 6: The method of any of aspects 1 through 4, further comprising: receiving, via a second other carrier, a second downlink control channel scheduling a third random access message based at least in part on receiving the second random access message via the second other carrier.

Aspect 7: The method of any of aspects 1 through 4, further comprising: receiving an indication of a third other carrier for a second downlink control channel scheduling a third random access message, wherein the indication of the third other carrier is received via the system information, the downlink control channel, the second random access message, or any combination thereof; and receiving, via the third other carrier, the second downlink control channel based at least in part on the indication of the third other carrier.

Aspect 8: The method of any of aspects 1 through 7, further comprising: receiving, via the first other carrier, a third downlink control channel scheduling a fourth random access message based at least in part on the indication of the first other carrier in the system information.

Aspect 9: The method of any of aspects 1 through 7, further comprising: receiving, via a second other carrier, a third downlink control channel scheduling a fourth random access message based at least in part on receiving the second random access message via the second other carrier.

Aspect 10: The method of any of aspects 1 through 7, further comprising: receiving, via a third other carrier, a third downlink control channel scheduling a fourth random access message based at least in part on receiving, via the third other carrier, a second downlink control channel scheduling a third random access message.

Aspect 11: The method of any of aspects 1 through 7, further comprising: receiving an indication of a fourth other carrier for a third downlink control channel scheduling a fourth random access message, wherein the indication of the fourth other carrier is received via the system information, the downlink control channel, the second random access message, a second downlink control channel scheduling a third random access message, or any combination thereof; and receiving, via the fourth other carrier, the third downlink control channel based at least in part on the indication of the fourth other carrier.

Aspect 12: The method of any of aspects 1 through 11, further comprising: receiving, via the first other carrier, a fourth random access message based at least in part on the indication of the first other carrier in the system information.

Aspect 13: The method of any of aspects 1 through 11, further comprising: receiving, via a second other carrier, a fourth random access message based at least in part on receiving the second random access message via the second other carrier.

Aspect 14: The method of any of aspects 1 through 11, further comprising: receiving, via a third other carrier, a fourth random access message based at least in part on receiving, via the third other carrier, a second downlink control channel scheduling a third random access message.

Aspect 15: The method of any of aspects 1 through 11, further comprising: receiving, via a fourth other carrier, a fourth random access message based at least in part on receiving, via the fourth other carrier, a third downlink control channel scheduling the fourth random access message.

Aspect 16: The method of any of aspects 1 through 11, further comprising: receiving an indication of a fifth other carrier for a fourth random access message, wherein the indication of the fifth other carrier is received via the system information, the downlink control channel, the second random access message, a second downlink control channel scheduling a third random access message, a third downlink control channel scheduling the fourth random access message, or any combination thereof; and receiving, via the fifth other carrier, the fourth random access message based at least in part on the indication of the fifth other carrier.

Aspect 17: The method of any of aspects 1 through 16, wherein the cell comprises a flexible cell that includes a set of non-aggregated carriers, the set of non-aggregated carriers comprising the anchor carrier, and the one or more other carriers and the one or more other carriers comprises one or more non-anchor carriers.

Aspect 18: The method of any of aspects 1 through 17, wherein the second random access message is a msg2 and the random access procedure is a four-step random access procedure or the second random access message is a msgB and the random access procedure is a two-step random access procedure.

Aspect 19: A method for wireless communication at a base station, comprising: transmitting, to a UE, system information for a cell that comprises an anchor carrier and one or more other carriers, the system information comprising an indication of a first other carrier of the one or more other carriers for transmitting a downlink control channel scheduling a second random access message; receiving, from the UE, a first random access message for a random access procedure; and transmitting, in response to the first random access message and via the first other carrier, the downlink control channel scheduling the second random access message.

Aspect 20: The method of aspect 19, further comprising: transmitting the second random access message via the first other carrier based at least in part on the indication of the first other carrier in the system information and in response to transmitting the downlink control channel scheduling the second random access message.

Aspect 21: The method of aspect 19, further comprising: transmitting, via the system information, an indication of a second other carrier for transmitting the second random access message; and transmitting the second random access message via the second other carrier based at least in part on the indication of the second other carrier in the system information and in response to transmitting the downlink control channel scheduling the second random access message.

Aspect 22: The method of aspect 19, further comprising: transmitting, via the downlink control channel, an indication of a second other carrier for transmitting the second random access message; and transmitting the second random access message via the second other carrier based at least in part on the indication of the second other carrier in the downlink control channel and in response to transmitting the downlink control channel scheduling the second random access message.

Aspect 23: The method of any of aspects 19 through 22, further comprising: transmitting, via the first other carrier, a second downlink control channel scheduling a third random access message based at least in part on the indication of the first other carrier in the system information.

Aspect 24: The method of any of aspects 19 through 22, further comprising: transmitting, via a second other carrier, a second downlink control channel scheduling a third random access message based at least in part on transmitting the second random access message via the second other carrier.

Aspect 25: The method of any of aspects 19 through 22, further comprising: transmitting an indication of a third other carrier for a second downlink control channel scheduling a third random access message, wherein the indication of the third other carrier is transmitted via the system information, the downlink control channel, the second random access message, or any combination thereof; and transmitting, via the third other carrier, the second downlink control channel based at least in part on the indication of the third other carrier.

Aspect 26: The method of any of aspects 19 through 25, further comprising: transmitting, via the first other carrier, a third downlink control channel scheduling a fourth random access message based at least in part on the indication of the first other carrier in the system information.

Aspect 27: The method of any of aspects 19 through 25, further comprising: transmitting, via a second other carrier, a third downlink control channel scheduling a fourth random access message based at least in part on transmitting the second random access message via the second other carrier.

Aspect 28: The method of any of aspects 19 through 25, further comprising: transmitting, via a third other carrier, a third downlink control channel scheduling a fourth random access message based at least in part on transmitting, via the third other carrier, a second downlink control channel scheduling a third random access message.

Aspect 29: The method of any of aspects 19 through 25, further comprising: transmitting an indication of a fourth other carrier for a third downlink control channel scheduling a fourth random access message, wherein the indication of the fourth other carrier is transmitted via the system information, the downlink control channel, the second random access message, a second downlink control channel scheduling a third random access message, or any combination thereof; and transmitting, via the fourth other carrier, the third downlink control channel based at least in part on the indication of the fourth other carrier.

Aspect 30: The method of any of aspects 19 through 29, further comprising: transmitting, via the first other carrier, a fourth random access message based at least in part on the indication of the first other carrier in the system information.

Aspect 31: The method of any of aspects 19 through 29, further comprising: transmitting, via a second other carrier, a fourth random access message based at least in part on transmitting the second random access message via the second other carrier.

Aspect 32: The method of any of aspects 19 through 29, further comprising: transmitting, via a third other carrier, a fourth random access message based at least in part on transmitting, via the third other carrier, a second downlink control channel scheduling a third random access message.

Aspect 33: The method of any of aspects 19 through 29, further comprising: transmitting, via a fourth other carrier, a fourth random access message based at least in part on transmitting, via the fourth other carrier, a third downlink control channel scheduling the fourth random access message.

Aspect 34: The method of any of aspects 19 through 29, further comprising: transmitting an indication of a fifth other carrier for a fourth random access message, wherein the indication of the fifth other carrier is transmitted via the system information, the downlink control channel, the second random access message, a second downlink control channel scheduling a third random access message, a third downlink control channel scheduling the fourth random access message, or any combination thereof; and transmitting, via the fifth other carrier, the fourth random access message based at least in part on the indication of the fifth other carrier.

Aspect 35: The method of any of aspects 19 through 34, wherein the cell comprises a flexible cell that includes a set of non-aggregated carriers, the set of non-aggregated carriers comprising the anchor carrier and the one or more other carriers, and the one or more other carriers comprises one or more non-anchor carriers.

Aspect 36: The method of any of aspects 19 through 35, wherein the second random access message is a msg2 and the random access procedure is a four-step random access procedure or the second random access message is a msgB and the random access procedure is a two-step random access procedure.

Aspect 37: An apparatus for wireless communication at a UE, comprising: a memory; and a processor, coupled to the memory, and configured to perform a method of any of aspects 1 through 18.

Aspect 38: An apparatus for wireless communication at a UE, comprising at least one means for performing a method of any of aspects 1 through 18.

Aspect 39: A non-transitory computer-readable medium storing code for wireless communication at a UE, the code comprising instructions executable by a processor to perform a method of any of aspects 1 through 18.

Aspect 40: An apparatus for wireless communication at a base station, comprising: a memory; and a processor, coupled to the memory, and configured to cause the apparatus to perform a method of any of aspects 19 through 36.

Aspect 41: An apparatus for wireless communication at a base station, comprising at least one means for performing a method of any of aspects 19 through 36.

Aspect 42: A non-transitory computer-readable medium storing code for wireless communication at a base station, the code comprising instructions executable by a processor to perform a method of any of aspects 19 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor, coupled to the memory, and configured to:
receive, from a base station, system information for a cell that comprises an anchor carrier and one or more other carriers, the system information comprising an indication of a first other carrier of the one or more other carriers for receiving a downlink control channel scheduling a second random access message;
transmit a first random access message for a random access procedure; and
receive, in response to the first random access message and via the first other carrier, the downlink control channel scheduling the second random access message.

2. The apparatus of claim 1, wherein the processor is further configure to:
receive the second random access message via the first other carrier based at least in part on the indication of the first other carrier in the system information and in response to receiving the downlink control channel scheduling the second random access message.

3. The apparatus of claim 1, wherein the processor is further configure to:
receive, via the system information, an indication of a second other carrier for receiving the second random access message; and
receive the second random access message via the second other carrier based at least in part on the indication of the second other carrier in the system information and in response to receiving the downlink control channel scheduling the second random access message.

4. The apparatus of claim 1, wherein the processor is further configure to:
receive, via the downlink control channel, an indication of a second other carrier for receiving the second random access message; and
receive the second random access message via the second other carrier based at least in part on the indication of the second other carrier in the downlink control channel and in response to receiving the downlink control channel scheduling the second random access message.

5. The apparatus of claim 1, wherein the processor is further configure to:
receive, via the first other carrier, a second downlink control channel scheduling a third random access message based at least in part on the indication of the first other carrier in the system information.

6. The apparatus of claim 1, wherein the processor is further configure to:
receive, via a second other carrier, a second downlink control channel scheduling a third random access message based at least in part on receiving the second random access message via the second other carrier.

7. The apparatus of claim 1, wherein the processor is further configure to:
receive an indication of a third other carrier for a second downlink control channel scheduling a third random access message, wherein the indication of the third other carrier is received via the system information, the downlink control channel, the second random access message, or any combination thereof; and
receive, via the third other carrier, the second downlink control channel based at least in part on the indication of the third other carrier.

8. The apparatus of claim 1, wherein the processor is further configure to:
receive, via the first other carrier, a third downlink control channel scheduling a fourth random access message based at least in part on the indication of the first other carrier in the system information.

9. The apparatus of claim 1, wherein the processor is further configure to:
receive, via a second other carrier, a third downlink control channel scheduling a fourth random access message based at least in part on receiving the second random access message via the second other carrier.

10. The apparatus of claim 1, wherein the processor is further configure to:
receive, via a third other carrier, a third downlink control channel scheduling a fourth random access message based at least in part on receiving, via the third other carrier, a second downlink control channel scheduling a third random access message.

11. The apparatus of claim 1, wherein the processor is further configure to:
receive an indication of a fourth other carrier for a third downlink control channel scheduling a fourth random access message, wherein the indication of the fourth other carrier is received via the system information, the downlink control channel, the second random access message, a second downlink control channel scheduling a third random access message, or any combination thereof; and
receive, via the fourth other carrier, the third downlink control channel based at least in part on the indication of the fourth other carrier.

12. The apparatus of claim 1, wherein the processor is further configure to:
receive, via the first other carrier, a fourth random access message based at least in part on the indication of the first other carrier in the system information.

13. The apparatus of claim 1, wherein the processor is further configure to:
receive, via a second other carrier, a fourth random access message based at least in part on receiving the second random access message via the second other carrier.

14. The apparatus of claim 1, wherein the processor is further configure to:
receive, via a third other carrier, a fourth random access message based at least in part on receiving, via the third other carrier, a second downlink control channel scheduling a third random access message.

15. The apparatus of claim 1, wherein the processor is further configure to:
receive, via a fourth other carrier, a fourth random access message based at least in part on receiving, via the fourth other carrier, a third downlink control channel scheduling the fourth random access message.

16. The apparatus of claim 1, wherein the processor is further configure to:
receive an indication of a fifth other carrier for a fourth random access message, wherein the indication of the fifth other carrier is received via the system information, the downlink control channel, the second random access message, a second downlink control channel scheduling a third random access message, a third downlink control channel scheduling the fourth random access message, or any combination thereof; and
receive, via the fifth other carrier, the fourth random access message based at least in part on the indication of the fifth other carrier.

17. The apparatus of claim 1, wherein:
the cell comprises a flexible cell that includes a set of non-aggregated carriers, the set of non-aggregated carriers comprising the anchor carrier; and
the one or more other carriers and the one or more other carriers comprises one or more non-anchor carriers.

18. The apparatus of claim 1, wherein:
the second random access message is a message 2 (msg2) and the random access procedure is a four-step random access procedure; or
the second random access message is a message B (msgB) and the random access procedure is a two-step random access procedure.

19. An apparatus for wireless communication at a base station, comprising:
a memory; and
a processor, coupled to the memory, and configured to:
transmit, to a user equipment (UE), system information for a cell that comprises an anchor carrier and one or more other carriers, the system information comprising an indication of a first other carrier of the one or more other carriers for transmitting a downlink control channel scheduling a second random access message;
receive, from the UE, a first random access message for a random access procedure; and
transmit, in response to the first random access message and via the first other carrier, the downlink control channel scheduling the second random access message.

20. The apparatus of claim 19, wherein the processor is further configure to:
transmit the second random access message via the first other carrier based at least in part on the indication of the first other carrier in the system information and in response to transmitting the downlink control channel scheduling the second random access message.

21. The apparatus of claim 19, wherein the processor is further configure to:
transmit, via the system information, an indication of a second other carrier for transmitting the second random access message; and
transmit the second random access message via the second other carrier based at least in part on the indication of the second other carrier in the system information and in response to transmitting the downlink control channel scheduling the second random access message.

22. The apparatus of claim 19, wherein the processor is further configure to:
transmit, via the downlink control channel, an indication of a second other carrier for transmitting the second random access message; and
transmit the second random access message via the second other carrier based at least in part on the indication of the second other carrier in the downlink control channel and in response to transmitting the downlink control channel scheduling the second random access message.

23. The apparatus of claim 19, wherein the processor is further configure to:
transmit, via the first other carrier, a second downlink control channel scheduling a third random access message based at least in part on the indication of the first other carrier in the system information.

24. The apparatus of claim 19, wherein the processor is further configure to:
transmit, via a second other carrier, a second downlink control channel scheduling a third random access message based at least in part on transmitting the second random access message via the second other carrier.

25. The apparatus of claim 19, wherein the processor is further configure to:
transmit, via the first other carrier, a third downlink control channel scheduling a fourth random access message based at least in part on the indication of the first other carrier in the system information.

26. The apparatus of claim 19, wherein the processor is further configure to:
transmit, via a second other carrier, a third downlink control channel scheduling a fourth random access message based at least in part on transmitting the second random access message via the second other carrier.

27. The apparatus of claim 19, wherein the processor is further configure to:
transmit, via a third other carrier, a third downlink control channel scheduling a fourth random access message based at least in part on transmitting, via the third other carrier, a second downlink control channel scheduling a third random access message.

28. The apparatus of claim 19, wherein the processor is further configure to:
transmit an indication of a fourth other carrier for a third downlink control channel scheduling a fourth random access message, wherein the indication of the fourth other carrier is transmitted via the system information, the downlink control channel, the second random access message, a second downlink control channel scheduling a third random access message, or any combination thereof; and
transmit, via the fourth other carrier, the third downlink control channel based at least in part on the indication of the fourth other carrier.

29. A method for wireless communication at a user equipment (UE), comprising:
receiving, from a base station, system information for a cell that comprises an anchor carrier and one or more other carriers, the system information comprising an indication of a first other carrier of the one or more other carriers for receiving a downlink control channel scheduling a second random access message;
transmitting a first random access message for a random access procedure; and
receiving, in response to the first random access message and via the first other carrier, the downlink control channel scheduling the second random access message.

30. A method for wireless communication at a base station, comprising:
transmitting, to a user equipment (UE), system information for a cell that comprises an anchor carrier and one or more other carriers, the system information comprising an indication of a first other carrier of the one or more other carriers for transmitting a downlink control channel scheduling a second random access message;
receiving, from the UE, a first random access message for a random access procedure; and
transmitting, in response to the first random access message and via the first other carrier, the downlink control channel scheduling the second random access message.
